(19) United States
(12) Patent Application Publication
(10) Pub. No.: US 2024/0360344 A1
(43) Pub. Date: Oct. 31, 2024

(54) CHEMICAL-RESISTANT, REACTIVE, PRESSURE-SENSITIVE ADHESIVE TAPE

(71) Applicant: tesa SE, Norderstedt (DE)

(72) Inventors: Maike-Christine Strebl-Pfarr, Hamburg (DE); Francisco Lossada, Norderstedt (DE); Christian Schuh, Hamburg (DE); Tahmina Schafa, Hamburg (DE)

(73) Assignee: tesa SE, Norderstedt (DE)

(21) Appl. No.: 18/645,170

(22) Filed: Apr. 24, 2024

(30) Foreign Application Priority Data
Apr. 28, 2023 (DE) 102023111057.8

(51) Int. Cl. C09J 7/38; C09J 133/14

(52) U.S. Cl. CPC C09J 7/385; C09J 133/14; C09J 2301/302; C09J 2433/00; C09J 2475/00

(57) ABSTRACT

A chemical-resistant, reactive pressure-sensitive adhesive tape having a reactive adhesive including a radically polymerizable monomer or oligomer, an initiator system for curing the at least one radically polymerizable monomer or oligomer, and a poly(meth)acrylate which contains a fraction of at least 15 percent by weight of monomers with aromatic radicals.

### CROSS-REFERENCE TO RELATED APPLICATION

This application claims the benefit of priority under 35 U.S.C. § 119 of German Patent Application No. DE102023111057.8, entitled “CHEMICAL-RESISTANT, REACTIVE, PRESSURE-SENSITIVE ADHESIVE TAPE”, and filed Apr. 28, 2023, the contents of which is relied upon and incorporated herein by reference in its entirety.

### FIELD OF THE DISCLOSURE

The present disclosure relates to a chemical-resistant, reactive, pressure-sensitive adhesive tape and to the use of such reactive pressure-sensitive adhesive tapes for bonding two or more components.

### BACKGROUND

The joining of separate elements is one of the central processes in manufacturing. In addition to other methods, such as welding and soldering, for example, adhesive bonding, i.e., joining using an adhesive, is of particular importance nowadays. An alternative here to the use of formless adhesives, which are applied from a tube, for example, are so-called adhesive tapes. From everyday life, pressure-sensitive adhesive tapes in particular are known, in which the bonding effect is ensured by a pressure-sensitive adhesive, which is permanently sticky and adhesive under normal ambient conditions. Corresponding pressure-sensitive adhesive tapes can be applied to a substrate by means of pressure and remain stuck there, but can later be removed in a more or less residue-free manner.

However, another type of adhesive tape is also of great importance, especially for use in industrial manufacturing. In these adhesive tapes, which are sometimes also referred to as reactive (pressure-sensitive) adhesive tapes, a curable adhesive, which is sometimes also referred to as reactive adhesive, is used. Appropriate curable adhesives or reactive adhesives have not yet reached their maximum degree of crosslinking in the state intended for application and can be cured by external influences, by initiating the polymerization in the reactive adhesive and thereby increasing the degree of crosslinking. The mechanical properties of the now cured adhesive change here, with the viscosity, surface hardness and strength increasing in particular.

Reactive adhesives are known in the prior art and can have very different compositions from a chemical point of view. These reactive adhesives have in common that the crosslinking reaction can be triggered by external influencing factors, for example by energy supply, in particular by temperature, plasma or radiation curing, and/or by contact with a polymerization-promoting substance, as is the case, for example, with moisture-curing adhesives. Illustrative adhesives are disclosed for example in DE 102015222028 A1, EP 3091059 A1, EP 3126402 B1, EP 2768919 B1, DE 102018203894 A1, WO 2017174303 A1 and U.S. Pat. No. 4,661,542 A.

Based on radically polymerizable monomers or oligomers, such as reactive acrylate monomers, for example, 2-component adhesive systems have been known for years. In these radically polymerizing systems, an adhesive film system consisting of two components is applied to the parts to be bonded, using either two liquid components or else two pressure-sensitive adhesive tapes. For example, one component consists of or comprises the monomers to be polymerized and an activator, while the other component consists of or comprises a radical-forming substance (also called hardener, curing agent or initiator) and the monomers to be polymerized. After mixing or at least contacting the two components, at least one radical is formed by a chemical reaction of the activator with the radical-forming substance, and the polymerization reaction of the monomers to be polymerized begins. The radical chain polymerization of the monomer then takes place until chain termination occurs, and the adhesive thus hardens, thereby achieving permanent bonding of the parts to be bonded. Such 2-component pressure-sensitive adhesive tapes based on reactive acrylate monomers are described, for example, in EP 300 847 A1, EP 3 010 989 A1, EP 3 063 243 A1, WO 2018/104053 A1 and EP 3 328 951 A1. A major disadvantage of these films is the fact that there are two films that have to be brought into form-fitting contact, which can become a problem especially if the surfaces to be bonded are very long and narrow and therefore the corresponding adhesive films must also be very long and narrow.

Single-component adhesive films based on acrylic monomers are also part of the generally known prior art. These are usually cured with light, especially UV light. The curing reaction is started with the help of a photoinitiator, which disintegrates after the absorption of (UV) light in a photolysis reaction and thus forms reactive species that trigger the radical polymerization. The speed of the curing reaction can be a disadvantage here, especially if non-transparent substrates are to be bonded. As soon as the reaction is triggered, there is usually not enough time left for joining the components to be bonded. Thus, such adhesive films are only suitable for the bonding of (UV-)transparent substrates, since the irradiation can then take place after the components have been joined, through the components. Another disadvantage of this type of adhesive film is that the polymerization does not continue as a dark reaction.

For example, DE 10 2019 209 513 A1 describes an adhesive film or pressure-sensitive adhesive tape based on acrylate monomers, which does not show these highlighted disadvantages of the prior art. A disadvantage here has been found to be inadequate damp heat resistance for many applications.

In EP 3 390 553 A1, a method is proposed in which an adhesive tape consisting of two interreacting layers A and B, which are separated from each other by a barrier layer, is reacted and thus cured by means of a laser, with the barrier layer being removed by the action of the laser light.

EP 3 126 402 A1 discloses a method in which a radical polymerization reaction is triggered by plasma treatment of an adhesive film containing a substance reactive with respect to a radical polymerization reaction and additionally a catalytically active substance. This method achieves a sufficiently slow curing rate.

DE 10 2021 125429 A1 discloses an adhesive film and, respectively, a pressure-sensitive adhesive tape comprising at least one reactive acrylate monomer, an initiator, a photoredox catalyst, (d) a polymer of N-vinyl compounds and a film-forming polymer.

Such pressure-sensitive adhesive tapes are particularly suitable for miniaturized applications, such as those required for example in the electronics industry. Here, it is increasingly important to implement the connections between the components with great precision and in a space-saving manner. In addition, owing to the still considerable worldwide demand for communications and entertainment electronics, the demands on the performance of the devices are also constantly increasing, so that the adhesive tapes used are also constantly subject to new, or at least growing, performance requirements. In particular, it is becoming increasingly important, for example owing to the development of body-worn electronic devices (wearables) such as smart watches, that the bonds used there have not only high bond strengths (as expected from (semi-)structural adhesives) but also high resistance to various chemicals (such as sweat, skin oil or sebum, sunscreen or cosmetic skincare products). This resistance to chemicals (so-called “chemical resistance”) is simulated by the cured pressure-sensitive adhesive tapes having acceptable bond strength even after prolonged storage in various media and ideally having hardly any or no loss of bond strength. Similar requirements are also increasingly being placed on other electronic devices such as smartphones, tablet PCs, notebook PCs, cameras, video-cameras, keyboards and touchpads.

Although the pressure-sensitive adhesive tapes known from the above-mentioned disclosures have a sufficiently high bond strength and in some cases also damp heat resistance when cured, the resistance to chemicals (chemical resistance) is present only to a small extent. In the light of the above, there is a great need for pressure-sensitive adhesive tapes that exhibit improved chemical resistance. Of course, it should also be borne in mind here that the (ultimate) bond strength, the diecuttability and the initial pressure-sensitive adhesiveness should be maintained at least at the same level.

### SUMMARY OF THE DISCLOSURE

The primary object of the present disclosure was to eliminate or at least reduce the above-described disadvantages of the prior art.

In particular, the object of the present disclosure was to provide a reactive pressure-sensitive adhesive tape which has an improved chemical resistance, for example to sweat, skin oil or sebum, sunscreen or cosmetic skincare products or to a mixture of isopropanol/water. In the development of adhesive tapes, a 7:3 mixture of isopropanol/water is often chosen in order to optimize adhesives for their chemical resistance to polar solvents. This mixture is therefore a so-called gatekeeper, which must be passed before the full spectrum of different chemicals is tested.

It was another object of the present disclosure was to provide a reactive pressure-sensitive adhesive tape which, in addition to a sufficient or improved chemical resistance, also has a high or improved bond strength.

Another object of the present disclosure was to provide a reactive pressure-sensitive adhesive tape which has a good or improved (initial) pressure-sensitive adhesiveness and at the same time has sufficient or improved chemical resistance.

A further object of the present disclosure was to provide a reactive pressure-sensitive adhesive tape which in the cured state has a high or improved bond strength.

In addition, it was a secondary object of the present disclosure to provide a use of the reactive pressure-sensitive adhesive tapes to be specified, for bonding two or more components.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### DETAILED DESCRIPTION

In the following detailed description, for purposes of explanation and not limitation, example embodiments disclosing specific details are set forth to provide a thorough understanding of various principles of the release liner of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an,” and “the” include plural referents unless the context clearly dictates otherwise. Thus, for example, reference to a “component” includes aspects having two or more such components, unless the context clearly indicates otherwise.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

All of the statements in the description apply to the chemical-resistant, reactive, pressure-sensitive adhesive tape of the disclosure.

The disclosure, moreover, embraces all the features which are subjects of any dependent claims. Further, the disclosure embraces combinations of individual features with one another, including at different preference levels. The disclosure thus embraces, for example, the combination of a first feature identified as being “preferred” with a second feature identified as being “particularly preferred”. In this context, subjects identified as part of “embodiments”, likewise at different preference levels, are also embraced.

In connection with the present disclosure, it has found that the above-described objects can be surprisingly achieved if a poly(meth)acrylate which contains a fraction of at least 15 percent by weight, more particularly of at least 55 percent by weight, of monomers with aromatic radicals is used as a basis in the reactive adhesive for the reactive pressure-sensitive adhesive tape of the disclosure, said radicals being such as phenyl, phenylene, naphthyl, or naphthylene, where phenyl or phenylene is particularly preferred, in combination with at least one radically polymerizable monomer or oligomer and at least one initiator system for curing the at least one radically polymerizable monomer or oligomer, as defined in the claims.

Surprisingly, in connection with this disclosure, it has been found that, contrary to expectations, that these fractions and also very high fractions (at least 65% by weight, at least 80% by weight or 100% by weight) of aromatic radicals in the poly(meth)acrylate lead to an improved chemical resistance of the overall system of the reactive adhesives, so that the reactive pressure-sensitive adhesive tapes of the disclosure have an improved chemical resistance. In addition, the it has been surprisingly found that the initial pressure-sensitive adhesiveness of the reactive pressure-sensitive adhesive tape of the disclosure with the reactive adhesive based on the poly(meth)acrylate with a fraction of at least 15 percent by weight of monomers with aromatic radicals is sufficiently high and the application (and repositioning) during use for bonding two components is very successful. In conclusion, it has been surprisingly found that the bond strengths of the reactive pressure-sensitive adhesive tapes of the disclosure (after curing) are sufficiently high to act as a (semi-)structural adhesive after curing. Preferably, the reactive pressure-sensitive adhesive tapes of the disclosure or the corresponding reactive adhesives act after curing as structural adhesives or semistructural adhesives. According to Deutsches Institut fir Normung (DIN) EN 923: 2006-01, structural adhesives are adhesives that form adhesive bonds that can maintain a specified strength in a structure for a mandated, relatively long period of time (according to American Society for Testing and Materials (ASTM) definition: “bonding agents used for transferring required loads between adherends exposed to service environments typical for the structure involved”). They are therefore adhesives for highly chemically and physically stressable bonds that contribute to the solidification of the adhesive tapes in the cured state.

The term “(semi-)structural adhesive” or “(semi-)structural adhesives” includes the “semi-structural adhesives” and the “structural adhesives”. “Semi-structural adhesives” are those cured adhesives which have a lap shear strength of at least 1.0 MPa in the lap shear test and more preferably of at least about 1.5 MPa (in each case on steel). “Structural adhesives” are those cured adhesives which have a particularly high lap shear strength and which have a lap shear strength of at least 5 MPa in the lap shear test, more preferably of at least 7 MPa and particularly preferably of at least 10 MPa (in each case on steel).

Without being tied to any particular theory, it is believed that the combination of (a) at least one poly(meth)acrylate which contains a fraction of at least 15 percent by weight of monomers with aromatic radicals, (b) at least one radically polymerizable monomer or oligomer, and (c) at least one initiator system for curing the at least one radically polymerizable monomer or oligomer acts synergistically in the reactive adhesive of the reactive pressure-sensitive adhesive tapes of the disclosure on the chemical resistance, the initial pressure-sensitive adhesiveness and the bond strength.

The above-stated objects are thus achieved by the subject-matter of the disclosure as defined in the claims. Preferred configurations according to the disclosure result from the dependent claims and from the observations below.

The disclosure relates to a reactive pressure-sensitive adhesive tape comprising at least one reactive adhesive containing a base mass, the base mass containing
(a) at least one poly(meth)acrylate, and
(b) at least one radically polymerizable monomer or oligomer, and the reactive adhesive additionally comprising
(c) at least one initiator system for curing the at least one radically polymerizable monomer or oligomer,
   wherein
   the poly(meth)acrylate derives from a monomer composition which comprises or consists of
(i) 15% by weight to 100% by weight of one or more monomers selected from the group consisting of
   a. one or more monomers of formula (I)

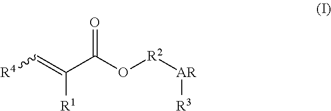

in which R¹ is a hydrogen atom or a methyl group,
R² is an unsubstituted, linear or branched C₁-C₂₂ alkyl chain,
AR is an aromatic radical,
R³ is H, an unsubstituted, linear or branched C₁-C₅ alkyl chain, a hydroxyl group, C₁-C₁₀ alkoxy group or aryloxy group,
R⁴ is H or a phenyl ring,
b. one or more monomers of formula (II)

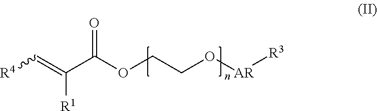

in which R¹ is a hydrogen atom or a methyl group,
AR is an aromatic radical,
R³ is H, an unsubstituted, linear or branched C₁-C₅ alkyl chain, a hydroxyl group, C₁-C₁₀ alkoxy group or aryloxy group, and
R⁴ is H or a phenyl ring, and n is 0 to 10,
c. styrene, and
d. methylstyrene; and
(ii) 0% by weight to 85% by weight of one or more comonomers,
   the comonomer or comonomers being selected from the group of (meth)acrylate monomers and copolymerizable vinyl monomers, and
   the comonomer or comonomers not corresponding to the monomers of formula (I),
   the monomers of formula (II), styrene and methylstyrene,
   the weight fractions being based in each case on the total weight of the monomer composition.

Embodiments which are hereinafter designated as preferred are combined in particularly preferred embodiments with features of other embodiments designated as preferred. Very particularly preferred, therefore, are combinations of two or more of the embodiments designated below as particularly preferred. Also preferred are embodiments in which a feature of one embodiment that is designated in any degree as preferred is combined with one or more further features of other embodiments that are designated in any degree as preferred. Features of preferred uses and methods result from the features of preferred reactive pressure-sensitive adhesive tapes.

For the purpose of optimal processability for the end user, the reactive adhesive of the present disclosure has pressure-sensitive adhesive properties or an intrinsic pressure-sensitive adhesiveness. The reactive adhesive can therefore be classified as a pressure-sensitive adhesive. The pressure-sensitive adhesiveness allows reliable and secure application of the reactive pressure-sensitive adhesive tapes on the substrate before curing.

A pressure-sensitive adhesive, in accordance with the expert understanding, is an adhesive compound which has pressure-sensitive adhesive properties, i.e., the property of making a permanent connection to a substrate even under relatively low contact pressure. Corresponding pressure-sensitive adhesive tapes are usually redetachable from the substrate after use, substantially free of residues, and generally are permanently inherently adhesive at room temperature, which means that they have a certain viscosity and touch-stickiness, so that they wet the surface of a substrate even at low contact pressure. The pressure-sensitive adhesiveness of a pressure-sensitive adhesive tape results from the fact that a pressure-sensitive adhesive is used as the adhesive. Without wishing to be tied to this theory, it is often assumed that a pressure-sensitive adhesive can be considered as an extremely high-viscosity fluid with an elastic component, which consequently has characteristic viscoelastic properties, which lead to the above-described permanent inherent adhesiveness and pressure-sensitive adhesive quality. It is assumed that with corresponding pressure-sensitive adhesives, mechanical deformation results in both viscous flow processes and the build-up of elastic restoring forces. The proportional viscous flow is used to achieve adhesion, while the proportional elastic restoring forces are necessary particularly for achieving cohesion. The relationships between rheology and pressure-sensitive adhesiveness are known in the prior art and are described, for example, in “Satas, Handbook of Pressure Sensitive Adhesive Technology”, third edition (1999), pages 153 to 203, which is incorporated herein by reference in its entirety.

For the more precise description and quantification of the measure of elastic and viscous component and of the ratio of the components to each other, the parameters storage modulus (G′) and loss modulus (G″), which can be determined by means of dynamic mechanical analysis (DMA), are used. G′ is a measure of the elastic component, G″ a measure of the viscous component of a substance. Both parameters are dependent on deformation frequency and temperature.

The parameters can be ascertained with the aid of a rheometer. The material to be examined is subjected to a sinusoidally oscillating shear stress in a plate-plate arrangement, for example. In the case of shear stress-controlled devices, deformation as a function of time and the time delay of this deformation are measured with respect to the onset of shear stress. This time delay is referred to as the phase angle δ. The storage modulus G′ is defined as follows: G′=(τ/γ)·cos(δ) (τ=shear stress, γ=deformation, δ=phase angle=phase shift between shear stress vector and deformation vector). The definition of the loss modulus G″ is: G″=(τ/γ)·sin(δ) (τ=shear stress, γ=deformation, δ=phase angle=phase shift between shear stress vector and deformation vector).

In the context of the present disclosure, an adhesive is preferably understood as being pressure-sensitive adhesive and thus as a pressure-sensitive adhesive when both G′ and G″ are at least partially in the range from 10³ to 10⁷ Pa at a temperature of 23° C. in the deformation frequency range from 10⁰ to 10¹ rad/sec. “Partially” means that at least one portion of the G′ curve is within the window spanned by the deformation frequency range of 10⁰ to 10¹ rad/sec inclusive (abscissa) and the range of G′ values of 10³ to 10⁷ Pa inclusive (ordinate), and if at least one portion of the G″ curve is also within the corresponding window.

For simplification, a reactive pressure-sensitive adhesive tape within the meaning of the present disclosure has a peel adhesion of at least 1 N/cm in the uncured state and that it is removed almost residue-free (i.e., adhesive failure in the test). Peel adhesion is determined here on steel analogously to International Organization for Standardization (ISO) 29862:2007 (method 3) at 23° C. and 50% relative atmospheric humidity at a peel rate of 300 mm/min and a peel angle of 180°. An etched polyethylene terephthalate (PET) film with a thickness of 36 μm, as available from Coveme (Italy), is used as a reinforcing film. The bonding of a 2 cm-wide test strip is undertaken here by means of a 4 kg roll applicator at a temperature of 23° C. The adhesive tape is peeled off immediately after application. The measured value (in N/cm) is obtained as the average value from three individual measurements. Cohesive failure in this test is shown at room temperature by sticky adhesives or adhesive tapes whose cohesion is not sufficient for residue-free removal. Such adhesives or adhesive tapes are not pressure-sensitive adhesives within the meaning of the disclosure.

The reactive pressure-sensitive adhesive tapes of the disclosure have a good or very good resistance to chemicals (so-called “chemical resistance”) and are regularly superior in this respect to known reactive pressure-sensitive adhesive tapes from the prior art, which often show no chemical resistance at all. The chemical resistance is characterized in particular by the fact that the pressure-sensitive adhesive tapes which are stored accordingly also lead to bonds whose properties after bonding, in particular their bond strengths, are very good. Pressure-sensitive adhesive tapes, on the other hand, which have poorer chemical resistance result in bonding products with lower stability when the bonding product is exposed to such conditions.

The reactive pressure-sensitive adhesive tapes of the disclosure show good chemical resistance with corresponding values in the push-out test (described later on below) of at least 0.01 MPa after storage for 72 h at 65° C. in isopropanol/water (70% volume fractions/30% volume fractions). Preferably, they show a very good chemical resistance with corresponding values in the push-out test (described later on below) of at least 0.1 MPa and, particularly preferably, they show an excellent chemical resistance with corresponding values in the push-out test (described later on below) of at least 0.3 MPa, both after storage for 72 h at 65° C. in isopropanol/water (70/30).

According to the disclosure, the term “poly(meth)acrylate” embraces polymers based on esters of acrylic acid and those based on esters of acrylic acid and methacrylic acid, and also those based on esters of methacrylic acid. According to the disclosure, the terms “(meth)acrylic acid ester” and “(meth)acrylate-” embrace both acrylic acid esters and methacrylic acid esters and both acrylates and methacrylates.

The reactive adhesive of the reactive pressure-sensitive adhesive tape of the disclosure comprises a base mass.

The base mass contains
(a) at least one poly(meth)acrylate of monomers (i) and (ii), and
(b) at least one radically polymerizable monomer or oligomer.

In addition, the base mass (d) may contain at least one further polymer.

The base mass is defined by the total amount of poly(meth)acrylates, further polymers and radically polymerizable monomers and oligomers.

The further polymers may be all polymers that are not poly(meth)acrylates of the monomers (i) and (ii).

The total weight of the constituents of the base mass of the reactive adhesive here and below is thus the total amount of poly(meth)acrylate of the monomers (i) and (ii) that is used, further polymers and radically polymerizable monomers and oligomers, which is obtained as the sum in percent by weight (% by weight) and corresponds to 100% by weight or always adds up to 100 percent by weight.

This means that in subsequently disclosed embodiments in which preferred configurations are disclosed for example for the poly(meth)acrylates according to (i), other, non-preferred poly(meth)acrylates as well must be used unchanged in the adhesive of the disclosure for the calculation of the weight fractions, since these also form a part of the base mass.

Any other optionally present constituents, such as solvents or water, are used only for preparation and in this appraisal are not included in the total weight of the constituents of the base mass. This also applies to solvents that may already be contained in the commercially available raw materials. In addition, the amount of any additives contained, as described below, is not included in the 100 percent by weight of the base mass.

The reactive adhesive contains preferably 50% or more, preferably 70% or more, particularly preferably 80% or more, very preferably 90% or more, more particularly preferably 95% or more, of the base mass, based on the total mass of the reactive adhesive.

The base mass of the reactive adhesive of the reactive pressure-sensitive adhesive tape according to the disclosure preferably comprises 10% by weight to 90% by weight of at least one poly(meth)acrylate (a), more preferably the base mass of the reactive adhesive comprises 20% by weight to 70% by weight and more particularly preferably 50% by weight to 70% by weight of at least one poly(meth)acrylate (a), based in each case on the total weight of the base mass of the reactive adhesive.

The weight percent figures (% by weight) refer to the at least one poly(meth)acrylate or to the sum of all poly(meth)acrylates if two or more poly(meth)acrylates are present.

In addition to 100% by weight of the base mass (c), the reactive adhesive contains at least one initiator system for curing the at least one radically polymerizable monomer or oligomer.

The poly(meth)acrylate or poly(meth)acrylates of the reactive adhesive in the reactive pressure-sensitive adhesive tape of the disclosure derives/derive from a monomer composition which comprises or consists of
(i) 15% by weight to 100% by weight of one or more monomers selected from the group consisting of
   a. one or more monomers of formula (I)

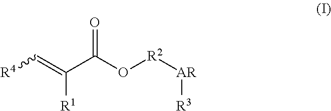

in which R¹ is a hydrogen atom or a methyl group,
R² is an unsubstituted, linear or branched C₁-C₂₂ alkyl chain,
AR is an aromatic radical,
R³ is H, an unsubstituted, linear or branched C₁-C₅ alkyl chain, a hydroxyl group, C₁-C₁₀ alkoxy group or aryloxy group,
R⁴ is H or a phenyl ring,
b. one or more monomers of formula (II)

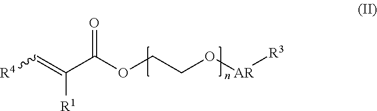

in which R¹ is a hydrogen atom or a methyl group,
AR is an aromatic radical,
R³ is H, an unsubstituted, linear or branched C₁-C₅ alkyl chain, a hydroxyl group, C₁-C₁₀ alkoxy group or aryloxy group, and
R⁴ is H or a phenyl ring, and n is 0 to 10,
c. styrene, and
d. methylstyrene; and
(ii) 0% by weight to 85% by weight of one or more comonomers,
   the comonomer or comonomers being selected from the group of (meth)acrylate monomers and copolymerizable vinyl monomers, and
   the comonomer or comonomers not corresponding to the monomers of formula (I),
   the monomers of formula (II), styrene and methylstyrene,
   the weight fractions being based in each case on the total weight of the monomer composition.

In principle, all radical or radical-controlled polymerizations can be used for the preparation of the poly(meth)acrylates, as well as combinations of different polymerization processes. In addition to conventional free radical polymerization, these include for example atom transfer radical polymerization (ATRP), nitroxide/TEMPO ((2,2,6,6-Tetramethylpiperidin-1-yl)oxyl)-controlled polymerization or the reversible addition fragmentation chain transfer (RAFT) process. The poly(meth)acrylates can be prepared by copolymerization of the (co)monomers using conventional polymerization initiators and optionally chain transfer agents, polymerization taking place at the usual temperatures in bulk, in emulsion, for example in water or liquid hydrocarbons, or in solution. Polymerization can be performed in polymerization reactors generally equipped with a stirrer, multiple feed vessels, reflux condensers, heating and cooling, and equipped for working under N₂ atmosphere and overpressure. Radical polymerization is carried out in the presence of one or more organic solvents and/or in the presence of water or in bulk. The aim here is to keep the amount of solvent used as small as possible. The polymerization time is usually between 6 and 48 hours, depending on conversion and temperature.

The weight-average molecular weight M_{w} of the poly(meth)acrylates, determined by means of gel permeation chromatography (GPC), is at least 20,000 g/mol in one preferred embodiment, more particularly at least 35,000 g/mol, preferably between 50,000 and 2,000,000 g/mol, more particularly between 100,000 and 2,000,000 g/mol, particularly preferably between 700,000 and 1,700,000 g/mol and most preferably between 1,000,000 and 1,700,000 g/mol.

Using mixtures of a high molecular weight (i.e., weight-average molecular weight M_{w} of >20,000 g/mol, in particular at least 35,000 g/mol) poly(meth)acrylate, composed exclusively of one or more comonomers (ii), and a low molecular weight (i.e., weight-average molecular weight M_{w} between 3,000 and 20,000 g/mol) poly(meth)acrylate, composed exclusively of one or more monomers (i), are also conceivable; in this case, the ratio of high molecular weight poly(meth)acrylate to low molecular weight poly(meth)acrylate should not be less than 0.5, preferably not less than 1, more particularly not less than 1.25, in order to achieve good pressure-sensitive adhesive properties in the uncured state.

The determination by gel permeation chromatography (GPC) is carried out as described in the Test Methods below.

For solution polymerization, solvents used are preferably esters of saturated carboxylic acids (e.g., ethyl acetate), aliphatic hydrocarbons (e.g., n-hexane or n-heptane), ketones (e.g., acetone or methyl ethyl ketone), special boiling point spirit or mixtures of these solvents. Preferably, a solvent mixture of acetone and isopropanol is used, wherein the isopropanol content is between 1 and 10 percent by weight. Customary radical-forming compounds, such as peroxides and azo compounds, for example, are commonly used as polymerization initiators. Initiator mixtures can also be used. In the polymerization, thiols can also be used as chain transfer agents to lower molecular weight and reduce polydispersity. Alcohols and ethers, for example, can be used as further chain transfer agents.

In one embodiment, the poly(meth)acrylates are obtained via the so-called “syrup method”. In an upstream step, the monomer composition is pre-polymerized to form a syrup. This syrup is then used in the formulation of the reactive adhesive and allowed to react after the coating step, for example, with light of a wavelength that does not activate the cationic initiator. The adhesive tapes of the disclosure can be obtained via this method.

The aromatic radical of the groups AR is preferably selected from the group consisting of phenyl groups, phenylene groups, naphthyl groups and naphthylene groups, which can optionally carry substituents. Particularly preferably, the aromatic radical AR is selected from the group consisting of phenyl groups, phenylene groups, naphthyl groups and naphthylene groups, with phenyl groups or phenylene groups being very particularly preferred.

A “phenylene group” is understood, in accordance with the expert understanding, to be a phenyl group that is at least divalent.

This applies in a similar way to naphthylene.

In one preferred embodiment, the monomers (i) contain a phenyl ring, i.e., AR in formula (I) stands for a phenyl group or a phenylene group and R⁴ stands for hydrogen, and therefore they are selected from the group consisting of
a. one or more monomers of formula (Ia)

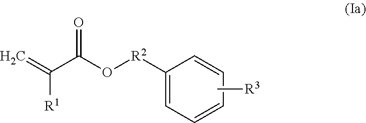

in which R¹ is a hydrogen atom or a methyl group,
R² is an unsubstituted, linear or branched C₁-C₂₂ alkyl chain, and
R³ is H, an unsubstituted, linear or branched C₁-C₅ alkyl chain, a hydroxyl group, C₁-C₁₀ alkoxy group or aryloxy group, and
b. one or more monomers of formula (IIa)

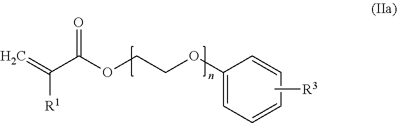

in which R¹ is a hydrogen atom or a methyl group,
R³ is H, an unsubstituted, linear or branched C₁-C₅ alkyl chain, a hydroxyl group, C₁-C₁₀ alkoxy group or aryloxy group, and n is 0 to 10.

The monomers (i) are preferably selected from the group of the monomers of formula (Ia) and the monomers of formula (IIa), preference being given in particular in the monomers of formula (IIa) to n=1 to 4, and in particular in the monomers of formula (IIa) to unsubstituted C₁-C₈ alkyl chain for R², and to H or tert-butyl for R³. In particular, the monomers (i) are selected from the following group: benzyl acrylate, phenyl acrylate, 2-phenylethyl acrylate, 3-phenylpropyl acrylate, 4-phenylbutyl acrylate, 5-phenylpentyl acrylate, 6-phenylhexyl acrylate, benzyl methacrylate, phenyl methacrylate, 2-phenylethyl methacrylate, 3-phenylpropyl methacrylate, 4-phenylbutyl methacrylate, 5-phenylpentyl methacrylate, 6-phenylhexyl methacrylate, 2-phenoxyethyl acrylate, 2-phenoxydiethylene glycol acrylate, 2-phenoxytriethylene glycol acrylate, 2-phenoxytetraethylene glycol acrylate, 2-phenoxypentaethylene glycol acrylate, 2-phenoxyhexaethylene glycol acrylate, 2-phenoxyheptaethylene glycol acrylate, 2-phenoxyoctaethylene glycol acrylate, 2-phenoxynonaethylene glycol acrylate, 2-phenoxydecaethylene glycol acrylate, 2-phenoxyethyl methacrylate, 2-phenoxydiethylene glycol methacrylate, 2-phenoxytriethylene glycol methacrylate, 2-phenoxytetraethylene glycol methacrylate, 2-phenoxypentaethylene glycol methacrylate, 2-phenoxyhexaethylene glycol methacrylate, 2-phenoxyheptaethylene glycol methacrylate, 2-phenoxyoctaethylene glycol methacrylate, 2-phenoxynonaethylene glycol methacrylate, 2-phenoxydecaethylene glycol methacrylate, 4-tert-butylphenyl acrylate, 4-tert-butylphenyl methacrylate, 2-(4-tert-butyl)phenoxyethyl acrylate, 2-(4-tert-butyl)phenoxydiethylene glycol acrylate, 2-(4-tert-butyl)phenoxytriethylene glycol acrylate, 2-(4-tert-butyl)phenoxytetraethylene glycol acrylate, 2-(4-tert-butyl)phenoxypentaethylene glycol acrylate, 2-(4-tert-butyl)phenoxyhexaethylene glycol acrylate, 2-(4-tert-butyl)phenoxyheptaethylene glycol acrylate, 2-(4-tert-butyl)phenoxyoctaethylene glycol acrylate, 2-(4-tert-butyl)phenoxynonaethylene glycol acrylate, 2-(4-tert-butyl)phenoxydecaethylene glycol acrylate, 2-(4-tert-butyl)phenoxyethyl methacrylate, 2-(4-tert-butyl)phenoxydiethylene glycol methacrylate, 2-(4-tert-butyl)phenoxytriethylene glycol methacrylate, 2-(4-tert-butyl)phenoxytetraethylene glycol methacrylate, 2-(4-tert-butyl)phenoxypentaethylene glycol methacrylate, 2-(4-tert-butyl)phenoxyhexaethylene glycol methacrylate, 2-(4-tert-butyl)phenoxyheptaethylene glycol methacrylate, 2-(4-tert-butyl)phenoxyoctaethylene glycol methacrylate, 2-(4-tert-butyl)phenoxynonaethylene glycol methacrylate, and 2-(4-tert-butyl)phenoxydecaethylene glycol methacrylate.

Particularly preferably, the monomers (i) are selected from the group consisting of benzyl acrylate, phenyl acrylate, benzyl methacrylate, phenyl methacrylate, 2-phenoxyethyl acrylate, 2-phenoxyethyl methacrylate. Most preferably, the monomers (i) are selected from benzyl acrylate and benzyl methacrylate.

In principle, the comonomers (ii) are selected from all of the skilled person's familiar (meth)acrylate monomers and other radically copolymerizable vinyl monomers, such as acrylonitrile or N-vinylcaprolactam, for example, which can be copolymerized with the monomers (i), where the comonomers (ii) do not correspond to the monomers (i), i.e., the monomers of formulas (I) or (Ia), formulas (II) or (IIa), styrene and methylstyrene.

Examples of such comonomers (ii) are acrylic acid, carboxyethyl acrylates, caprolactone acrylate, 1,4-cyclohexanedimethanol monoacrylate, 2,3-dihydroxypropyl methacrylate, 4-hydroxybutyl acrylate, 2-hydroxyethyl acrylate, 2-hydroxyethyl methacrylate, hydroxypropyl acrylate, n-butyl acrylate, n-butyl methacrylate, behenyl acrylate, behenyl methacrylate, cetyl acrylate, ethyl acrylate, ethyl methacrylate, 2-ethylhexyl acrylate, 2-ethylhexyl methacrylate, 2-ethylhexyl diglycol acrylate, n-hexyl acrylate, isobutyl acrylate, isobutyl methacrylate, icosyl acrylate, isoheptadecyl acrylate, isoheptadecyl methacrylate, isostearyl acrylate, isodecyl acrylate, isodecyl methacrylate, isononyl acrylate, isooctyl acrylate, lauryl acrylate, lauryl methacrylate, tetradecyl acrylate, methyl acrylate, methyl methacrylate, methoxyethyl acrylate, n-octyl acrylate, 2-octyl acrylate, n-decyl acrylate, propylheptyl acrylate, stearyl acrylate, stearyl methacrylate, tert-butyl acrylate, tert-butyl methacrylate, cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, tetrahydrofurfuryl acrylate, 3,3,5-trimethylcyclohexyl acrylate, tert-butylcyclohexyl methacrylate, ethylene diglycol acrylate, potassium 3-sulfopropyl acrylate, 2-(0-[1′-methylpropylideneamino]carboxyamino)ethyl methacrylate, 2-[(3,5-dimethylpyrazolyl)carboxyamino]ethyl methacrylate, polypropylene glycol monomethacrylate, ureidomethacrylate, methacrylamide, 4-acryloylmorpholine, acrylonitrile, N,N-dimethylacrylamide, N-tert-butylacrylamide, N-methylolmethacrylamide, N-vinylcaprolactam, N-vinylpyrrolidone, vinylmethyloxazolidinone, maleic anhydride, and vinyl acetate.

Preferably, the glass transition temperature (T_{g}) of a homopolymer of the respective comonomer (ii) is greater than 0° C., preferably greater than 10° C., more particularly greater than 20° C., and particularly preferably greater than 30° C. In particular, the group of comonomers (ii) does not comprise monomers containing more than one radically polymerizable group, as this leads to crosslinking. Therefore, a noncrosslinked poly(meth)acrylate is particularly preferred for the purposes of this disclosure.

In one preferred embodiment, in the reactive pressure-sensitive adhesive tape of the disclosure, the poly(meth)acrylate derives from a monomer composition which comprises a nitrogen-containing comonomer (ii).

Suitable preferred comonomers (ii) are selected from the group consisting of acrylic acid, 1,4-cyclohexanedimethanol monoacrylate, 2,3-dihydroxypropyl methacrylate, 2-hydroxyethyl methacrylate, n-butyl methacrylate, behenyl acrylate, behenyl methacrylate, cetyl acrylate, ethyl methacrylate, 2-ethylhexyl methacrylate, 2-ethylhexyl diglycol acrylate, n-hexyl acrylate, isobutyl acrylate, isobutyl methacrylate, icosyl acrylate, isononyl acrylate, tetradecyl acrylate, methyl acrylate, methyl methacrylate, stearyl acrylate, tert-butyl acrylate, tert-butyl methacrylate, cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, 3,3,5-trimethylcyclohexyl acrylate, tert-butylcyclohexyl methacrylate, potassium 3-sulfopropyl acrylate, 2-(0-[1′-methylpropylideneamino]carboxyamino)ethyl methacrylate, 2-[(3,5-dimethylpyrazolyl)carboxyamino]ethyl methacrylate, ureidomethacrylate, methacrylamide, 4-acryloylmorpholine, acrylonitrile, N,N-dimethylacrylamide, N-tert-butylacrylamide, N-methylolmethacrylamide, N-vinylcaprolactam, N-vinylpyrrolidone, vinylmethyloxazolidinone, maleic anhydride, and vinyl acetate.

Particularly suitable as comonomers (ii) are (meth)acrylic acid esters selected from the group consisting of (meth)acrylic acid esters having cyclic carbon side groups, (meth)acrylic acid esters having linear or branched carbon side groups and having more than 10 carbon atoms, and (meth)acrylic acid esters having a homopolymer T_{g} of greater than 0° C.

Particularly preferably, the comonomers (ii) are selected from the group consisting of: stearyl acrylate, methyl acrylate, tert-butyl acrylate, cyclohexyl acrylate, dihydrodicyclopentadienyl acrylate, isobornyl acrylate, 1,4-cyclohexanedimethanol monoacrylate, methyl methacrylate, 2-hydroxyethyl methacrylate, tert-butylcyclohexyl methacrylate, behenyl methacrylate, n-butyl methacrylate, cyclohexyl methacrylate, ethyl methacrylate, isobutyl methacrylate, tert-butyl methacrylate, isobornyl methacrylate, tert-butylcyclohexyl methacrylate, 3,4-epoxycyclohexylmethyl methacrylate, and glycidyl methacrylate. Particularly preferred are methyl methacrylate, isobornyl acrylate, methyl acrylate, and stearyl acrylate.

Surprisingly, it has been found that comonomers (ii) selected from the group of (meth)acrylic acid esters whose carbon side groups are linear or branched and have more than 10 carbon atoms can have a weight fraction of up to 30% by weight, preferably up to 25% by weight, more particularly up to 20% by weight of the total weight of the monomer composition and have no negative influence on the chemical resistance of the reactive adhesive of the disclosure.

Preferably, these are comonomers (ii) selected from the group consisting of lauryl acrylate, lauryl methacrylate, tetradecyl acrylate, stearyl methacrylate, cetyl acrylate, tetradecyl acrylate, and stearyl acrylate; more particularly preferably selected from the group consisting of cetyl acrylate, tetradecyl acrylate, and stearyl acrylate.

Furthermore, it was observed that comonomers (ii) selected from the group of (meth)acrylic acid esters which have cyclic carbon side groups can also have a weight fraction of up to 30% by weight, preferably 25% by weight, more particularly up to 20% by weight of the total weight of the monomer composition. Without being tied to a particular theory, it is believed that such groups do not influence chemical resistance in either one direction (polar solvents) or the other (nonpolar solvents), owing to the mixing of the more polar ester group and the more nonpolar cyclic moieties.

Examples of such comonomers (ii) are selected from the group consisting of cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, 3,3,5-trimethylcyclohexyl acrylate, tert-butylcyclohexyl methacrylate, 4-acryloylmorpholine, N-vinylcaprolactam, N-vinylpyrrolidone, and vinylmethyloxazolidinone. Particularly preferably, the comonomers (ii) are selected from the group consisting of cyclohexyl acrylate, cyclohexyl methacrylate, (5-ethyl-1,3-dioxan-5-yl)methyl acrylate, dihydrodicyclopentadienyl acrylate, isobornyl acrylate, isobornyl methacrylate, norbornyl acrylate, 4-tert-butylcyclohexyl acrylate, 3,3,5-trimethylcyclohexyl acrylate, and tert-butylcyclohexyl methacrylate.

The monomer composition from which the poly(meth)acrylate or poly(meth)acrylates of the reactive adhesive in the reactive pressure-sensitive adhesive tape of the disclosure derive usually consists of up to 15 different monomers. Preferably, the monomer composition consists of up to 5 different monomers, more preferably of 4 different monomers, even more preferably of 3 different monomers, more preferably still of 2 different monomers and preferentially of one monomer and thus only of a monomer (i). In the case of a total of two monomers, both monomers preferably belong to the group of monomers (i) and in the case of a total of three monomers, either two or all three of the monomers belong to the group of monomers (i).

It is particularly preferred that the monomer composition consists of a monomer (i) which is preferably selected from benzyl acrylate and benzyl methacrylate, or that the monomer composition consists of two monomers (i) which are selected from the group consisting of benzyl acrylate, phenyl acrylate, benzyl methacrylate, phenyl methacrylate, 2-phenoxyethyl acrylate, 2-phenoxyethyl methacrylate, and preferably selected from the group consisting of phenoxyethyl acrylate, 2-phenoxyethyl methacrylate, benzyl acrylate and benzyl methacrylate. Preferred combinations here are 2-phenoxyethyl acrylate and 2-phenoxyethyl methacrylate, benzyl acrylate and benzyl methacrylate, or 2-phenoxyethyl acrylate and benzyl methacrylate.

The poly(meth)acrylate or poly(meth)acrylates of the reactive adhesive in the reactive pressure-sensitive adhesive tape of the disclosure derives/derive from a monomer composition which comprises or consists of 15% by weight to 100% by weight of one or more monomers (i) and 0% by weight to 85% by weight of one or more comonomers (ii). In particular, the monomer composition contains 55% by weight to 100% by weight of one or more monomers (i) and more preferably 65% by weight to 100% by weight, 70% by weight to 100% by weight, 75% by weight to 100% by weight, 80% by weight to 100% by weight or 90% by weight to 100% by weight of one or more monomers (i). Corresponding amounts of one or more comonomers (ii) are contained, so that a total of 100% by weight is achieved. Preference is given to 55% by weight to 100% by weight, more preferably 65% by weight to 100% by weight, even more preferably 80% by weight to 100% by weight and most preferably 100% by weight of one or more monomers (i).

In a preferred embodiment, the poly(meth)acrylate or the poly(meth)acrylates of the reactive adhesive in the reactive pressure-sensitive adhesive tape according to the disclosure are substantially inert with respect to the at least one radically polymerizable monomer or oligomer and the at least one initiator system and, where relevant, the other substances. In this context, inert means that the radically polymerizable monomers or oligomers and the at least one initiator system and the other substances, if any, substantially do not react with the poly(meth)acrylate or poly(meth)acrylates polymer under suitably selected conditions, especially at room temperature (23° C.), prior to light curing.

For this reason, in a preferred embodiment, no acid, in particular no acrylic acid or other monomers having one or more carboxyl groups, and no amines, in particular no tertiary amines, are contained as comonomer(s) (ii) in the monomer composition of the poly(meth)acrylate. In a specific embodiment, the poly(meth)acrylate or poly(meth)acrylates are additionally inert even after activation of the curing reaction. This means that the poly(meth)acrylate does not react in the radical reaction.

The base mass of the reactive adhesive of the reactive pressure-sensitive adhesive tape of the disclosure comprises at least one radically polymerizable monomer or oligomer (b). In accordance with the expert understanding, the radically polymerizable monomer or oligomer shall represent a monomer or oligomer capable of radical chain polymerization.

By radically polymerizable oligomers, the skilled person in particular means radically polymerizable compounds having a molecular weight distribution weight average M_{w} of less than 35,000 g/mol, in particular less than 15,000 g/mol, in particular less than 10,000 g/mol, and in this case, in the context of the present disclosure, more particularly acrylated or methacrylated ether oligomers, butadiene oligomers, ester oligomers, carbonate oligomers, silicone oligomers, epoxy compounds having a molecular weight distribution weight average M_{w} of less than 35,000 g/mol, in particular less than 15,000 g/mol, in particular less than 10,000 g/mol. These include epoxy (meth)acrylates, aliphatic, aromatic and silicone urethane (meth)acrylates, aliphatic and aromatic polyester (meth)acrylates, polybutadiene (meth)acrylates, dendritic (meth)acrylates, polyether (meth)acrylates and polycarbonate (meth)acrylates available for example from Miwon and Bomar, such as MIRAMER SC2565 with an M_{w} of 5,200 g/mol from Miwon. The functionality of the polymerizable oligomers, i.e., the number of radically polymerizable groups per molecule, is preferably 1 to 20, usually 2 to 15, mainly 2 to 6. The dynamic viscosity, determined according to DIN 53019-1 from 2008, at 25° C. is preferably greater than 1 Pa·s, but particularly preferably well above 10 Pa·s. In particular, for the production of good pressure-sensitive adhesives, with sufficient cohesion, oligomers are suitable as a constituent of the adhesive with dynamic viscosities at 25° C. of greater than 20 Pa·s, preferably greater than 30 Pa·s. In the context of the present disclosure, the dynamic viscosity is determined according to DIN 53019-1 from 2008; at 25° C., with a shear rate of 1 s⁻¹.

A suitable radically polymerizable monomer is selected from the group consisting of acrylic acid esters (such as 2-ethylhexyl acrylate), methacrylic acid esters, vinyl compounds and compounds with carbon-carbon double bonds, and also crosslinking radically polymerizable monomers such as diacrylates, dimethacrylates, triacrylates, trimethacrylates and higher-functional acrylates or higher-functional methacrylates. Suitable radically polymerizable oligomers are oligomeric substances with acrylate or methacrylate function; the functionalization may be single or multiple.

In one embodiment, in the reactive pressure-sensitive adhesive tape of the disclosure, the at least one radically polymerizable monomer or oligomer has a boiling point at 1 mbar of at least 30° C., preferably at least 60° C., and particularly preferably of at least 80° C., or is present as a solid at 23° C. In this context, radically polymerizable oligomers are particularly preferred. Therefore, in a preferred embodiment, in the reactive pressure-sensitive adhesive tape of the disclosure, the base mass of the reactive adhesive comprises a radically polymerizable oligomer.

Preferred monomers with regard to a high bond strength are acrylic acid esters and/or methacrylic acid esters in which the alcohol part of the ester contains functional groups. Preferred functional groups are aromatic groups, urethane groups, urea groups, oxygen or nitrogen heterocycles, ether groups, ester groups or hydroxyl groups.

Examples of preferred monomers are 2-phenoxyethyl acrylate (CAS No.: 48145-04-6), 2-phenoxyethyl methacrylate (CAS No.: 10595-06-9), 2-hydroxy-3-phenoxypropyl acrylate (CAS No.: 16969-10-1), 2-hydroxy-3-phenoxypropyl methacrylate (CAS No.: 16926-87-7), 2-[2-(methacryloyloxy)ethoxycarbonyl]benzoic acid (CAS No.: 27697-00-3), 2-[[(phenylamino)carbonyl]oxy]ethyl methacrylate (CAS No.: 51727-47-0), 2-tert-butyl-6-[(3-tert-butyl-2-hydroxy-5-methylphenyl)methyl]-4-methylphenylprop-2-enoate (CAS No.: 61167-58-6), (5-ethyl-1,3-dioxan-5-yl)methyl acrylate (CAS No. 66492-51-1), (2-oxo-1,3-dioxolan-4-yl)methyl methacrylate (CAS No.: 13818-44-5), di(ethylene glycol) 2-ethylhexyl ether acrylate (CAS No.: 117646-83-0), (2,2-dimethyl-1,3-dioxolan-4-yl)methyl prop-2-enoate (CAS No.: 13188-82-4), succinic acid mono[2-(acryloyloxy)ethyl ester] (CAS No.: 50940-49-3), succinic acid mono[2-(methacryloyloxy)ethyl ester] (CAS No.: 20882-04-6), (2,2-pentamethylene-1,3-oxazolid-3-yl)ethyl methacrylate (CAS No.: 4203-89-8), 2-hydroxy-3-(prop-2-enoyloxy)propyl 2-methyl-2-propylhexanoate (CAS No.: 444649-70-1), 2-[[(butylamino)carbonyl]oxy]ethyl acrylate (CAS No.: 63225-53-6), stearyl acrylate (CAS No.: 4813-57-4), stearyl methacrylate (CAS No.: 32360-05-7), and the crosslinking monomers diurethane dimethacrylate (isomer mixture) (CAS No.: 72869-86-4), bisphenol A glycerolate dimethacrylate (BIS-GMA, CAS No.: 1565-94-2), bisphenol A dimethacrylate (BIS-DMA, CAS No.: 3253-39-2), ethylene glycol diacrylate (CAS No.: 2274-11-5), ethylene glycol dimethacrylate (CAS No.: 97-90-5), trimethylolpropane propoxylate triacrylate (CAS No.: 53879-54-2), trimethylolpropane triacrylate (CAS No.: 15625-89-5), and/or di(trimethylolpropane) tetraacrylate (CAS No.: 94108-97-1). Particularly preferred are 2-hydroxy-3-phenoxypropyl acrylate, 2-[[(butylamino)carbonyl]oxy]ethyl acrylate, and diurethane dimethacrylate.

For good chemical resistance, acrylic acid esters and/or methacrylic acid esters are preferred that have a phenyl group and a hydroxyl group as functional groups, such as 2-hydroxy-3-phenoxypropyl acrylate.

The base mass of the reactive adhesive of the reactive pressure-sensitive adhesive tape of the disclosure preferably comprises 10% by weight to 80% by weight of at least one radically polymerizable monomer or oligomer (b), more preferably the base mass of the reactive adhesive comprises 20% by weight to 60% by weight and more particularly preferably 35% by weight to 45% by weight of at least one radically polymerizable monomer or oligomer (b), based in each case on the total weight of the constituents of the base mass of the reactive adhesive.

The stated weight percentages refer to the radically polymerizable monomer or oligomer or to the sum of all monomers and/or oligomers, if two or more monomers and/or oligomers are present. Solvents or water are only used for preparation and are generally not included in this application in the total mixture of the constituents of the reactive pressure-sensitive adhesive tape of the disclosure or the reactive adhesive or the base mass of the reactive adhesive. This also applies to solvents that may already be contained in the commercially available raw materials.

Preferably, in the reactive adhesive of the reactive pressure-sensitive adhesive tape of the disclosure, the weight ratio of the entirety of the poly(meth)acrylates to the entirety of the radically polymerizable monomers or oligomers is 3:1 to 1:3, more preferably 2:1 to 1:2, more particularly 1.5:1 to 1:1.5.

The reactive adhesive of the reactive pressure-sensitive adhesive tape of the disclosure comprises, in addition to the base mass, at least one initiator system (c) for curing the at least one radically polymerizable monomer or oligomer. In the presently intended use of at least one radically polymerizable monomer or oligomer, the polymerization is preferably carried out by means of radical polymerization. Therefore, the reactive adhesive comprises an initiator system for radical polymerization.

The reactive adhesive of the reactive pressure-sensitive adhesive tape of the disclosure preferably comprises 0.1% by weight to 10% by weight of at least one initiator system (c) for curing the at least one radically polymerizable monomer or oligomer, more preferably the reactive adhesive comprises 0.1% by weight to 5% by weight and more particularly preferably 0.1% by weight to 2% by weight of at least one initiator system (c), based in each case on 100% by weight of base mass.

If a UV-transparent substrate is being bonded, then in one embodiment the activation can take place after the joining of the second substrate. In this case, the initiator system can be a photoinitiator, as known to the skilled person and described, for example, in “Industrial Photoinitiators—A Technical Guide” by W. A. Green, published by Taylor and Francis, which is incorporated herein by reference. One possible example of such a photoinitiator is BASF's Irgacure 651.

In one preferred embodiment, the initiator system (c) for curing the at least one radically polymerizable monomer or oligomer consists of at least one radical initiator (c1) and at least one photoredox catalyst (c2).

As used herein, the term radical initiator or radical-forming substance stands for a compound that can initiate a polymerization reaction or crosslinking polymerization reaction of the radically polymerizable monomer or oligomer. However, the radical initiator participates in the reaction process to a very small extent and therefore does not form a polymer component that determines the properties of the bonding.

The radical initiator is preferably chosen such that it does not trigger polymerization in the mixture with the radically polymerizable monomers or oligomers at temperatures up to 90° C., even if the mixture is irradiated with UV or blue light. This applies as long as no photoredox catalyst or other activating substance is added to the mixture.

In principle, all known prior-art radical initiators can be used. Preferred radical initiators are peroxides, especially hydroperoxides. In a particularly preferred embodiment according to the disclosure, the radical initiator (c1) is an organic peroxide, such as peroxycarboxylic acids and hydroperoxides. Hydroperoxides, in particular diisopropylbenzene hydroperoxide (CAS No. 26762-93-6), are particularly preferred.

Diisopropylbenzene hydroperoxide is preferably used in the form of a 50-weight-percent solution of diisopropyl hydroperoxide in diisopropylbenzene, available under the trade name Peroxan® IHP-50 (Pergan GmbH, Bocholt, Germany). α,α-Dimethylbenzyl hydroperoxide, also known as cumene hydroperoxide (CAS No. 80-15-9), can also be used. In addition, p-menthane hydroperoxide (CAS No. 26762-92-5), tert-amyl hydroperoxide (CAS No. 3425-61-4), tert-butyl hydroperoxide (CAS No. 75-91-2), or 1,1,3,3-tetramethylbutyl hydroperoxide (CAS No. 5809-08-5), for example, may also be used.

In one preferred embodiment, in the reactive pressure-sensitive adhesive tape of the disclosure, the at least one radical initiator (c1) is an organic peroxide, preferably a hydroperoxide and most preferably diisopropylbenzene hydroperoxide. In one preferred embodiment, the reactive adhesive contains no (or less than 0.001% by weight of) tertiary amines, because these react with peroxides and then radicals are released, so that the storage stability is negatively affected.

The proportion of the radical initiator (c1) in the reactive adhesive of the reactive pressure-sensitive adhesive tape of the disclosure is preferably in the range from 0.1% by weight to 9% by weight, particularly preferably from 0.1% by weight to 5% by weight, and particularly preferably from 0.1% by weight to 2% by weight of radical initiator, based in each case on 100% by weight of base mass.

As used here, the term photoredox catalyst stands for a light- or UV-light-sensitive compound that, when excited by light or UV light, can mediate the transfer of electrons between chemical compounds that would otherwise react more slowly or not at all. In contrast to a photoinitiator, a photoredox catalyst does not decompose into reactive cleavage products when irradiated with light or UV light, but is merely put into an excited state, which is usually relatively long-lasting and from which redox processes can be initiated or mediated. The photoredox catalyst preferably does not trigger polymerization in the mixture with the radically polymerizable monomers or oligomers at temperatures up to 90° C., even if the mixture is irradiated with UV or blue light. This applies as long as no radical initiator or other initiating substance is added to the mixture. The photoredox catalyst is therefore not an initiator or radical initiator. When irradiated with UV or blue light, it only activates the initiator, which then triggers polymerization.

Photoredox catalysts (c2) used may be the photoredox catalysts known to the person skilled in the art. Photoredox catalysts are often transition metal complexes, which are neutral or in cation form depending on the ligands, with ruthenium, copper, or iridium as the central atom. As ligands of the transition metal complex, bidentate ligands can preferably be used, in particular those having at least two interconnected heteroaromatic six-membered rings, for instance in the form of a biphenyl, which in turn can be part of a more complex structure—such as polycyclic aromatic hydrocarbons and/or bridged—bicyclic or polycyclic—aromatic hydrocarbons. If ligands containing biphenyl structural units are used, one each of the aromatic rings of the biphenyl can advantageously form a “tooth” of the ligand, so giving the bidenticity. Bicyclic aromatic compounds—such as biphenyl compounds—or polycyclic aromatic compounds as ligands can be unsubstituted—that is, carry a hydrogen atom on every C atom—or be substituted one or more times. The transition metal complex acts as a photoredox catalyst within the meaning of the present disclosure.

With particular advantage, a transition metal complex is used according to the disclosure that can be described by the following formula (III) or which comprises at least one structural unit which can be described by the formula (III):

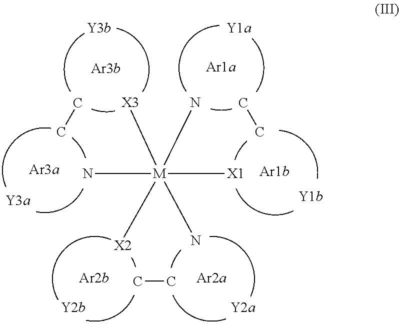

where
M stands for either ruthenium or iridium,
N stands for nitrogen,
C stands for carbon,
X1, X2, X3—hereinafter also referred to briefly as X, if the distinction is not important or generally valid statements are made for these building blocks—each stand for nitrogen (N) or carbon (C), alternatively and independently of each other,
Y1a, Y1b, Y2a, Y2b, Y3a, Y3b—hereinafter also referred to briefly as Y, if the distinction is not important or generally valid statements are made for these building blocks—each alternatively and independently of each other stand for nitrogen (N) or carbon with hydrogen bonded to them (CH), and where
Ar1a, Ar2a, Ar3a (in a circle) each represent a heteroaromatic six-membered ring (i.e., heterocyclic aromatic six-membered ring), where the one respective heteroatom or, where present, the two respective heteroatoms is/are nitrogen (N)—and the remaining atoms of the ring are accordingly carbon (C),
Ar1b, Ar2b, Ar3b (in a circle) each alternatively and independently of each other stand for a carbocyclic aromatic six-membered ring or for a heterocyclic aromatic six-membered ring, where the one respective heteroatom or, where present, the two respective heteroatoms is/are each nitrogen (N)—and the remaining atoms of the ring are accordingly carbon (C),
where Ar1a with Ar1b, Ar2a with Ar2b and Ar3a with Ar3b are each linked via carbon-carbon bonds (C—C), so that in each case a hetero-biphenylic structural element is obtained.

The location and position of the atoms (C, N, X (with their respective specifications), Y (with its respective specifications)) in the cycles Ar1a, Ar2a, Ar3a, Ar1b, Ar2b, Ar3b should fundamentally not be limited by the above-selected representation; in particular, the selected representation initially means only that the atoms specified for the ring are also present in it. Preferably, however, the bicycles comprise the respective unit N—C—C—X (with X as a placeholder for X1, X2 and X3 respectively), in which the respective atoms are adjacent and N—C and C—X are parts of the respective aromatic (conjugated) ring.

The carbon atoms (C) (those not represented with letter symbols) in the cycles Ar1a, Ar2a, Ar3a, Ar1b, Ar2b, Ar3b can have hydrogen bonded to them, independently of each other, but they can also be substituted, so that both the carbocyclic and the heterocyclic aromatic rings (Ar1a, Ar1b, Ar2a, Ar2b, Ar3a, Ar2b, Ar3a, Ar3b) are either alternatively and independently unsubstituted, singly substituted or multiply substituted derivatives of the corresponding six-membered rings.

Possible substituents include, for example, halogenyl groups, alkyl groups, aryl groups, heteroaryl groups, halogenylalkyl groups, halogenylaryl groups or halogenylheteroaryl groups.

In a preferred embodiment, all these substituents are chosen to be hydrogen (H). In another preferred embodiment of the disclosure, certain of these substituents are chosen to be halogen atoms, for instance to be fluorine. For example, each of the cycles Ar1a, Ar2a, Ar3a, Ar1b, Ar2b, Ar3b can carry two fluorine atoms as substituents.

Some of the substituents can also constitute bridges to the neighboring ring of the respective biphenyl, so that a compound of the general formula (IV) results:

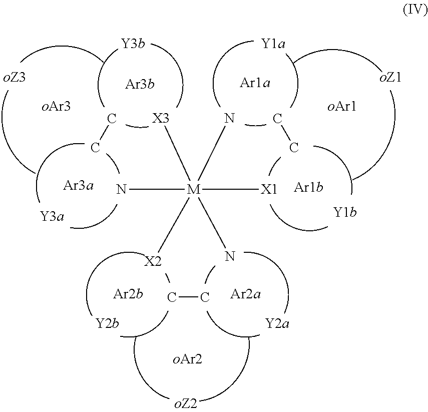

where the symbol explanations described for formula (I) apply and additionally oZ1, oZ2, oZ3—hereinafter also referred to briefly as oZ, if the distinction does not matter or generally valid statements are made for these components—are each present optionally such that at least one of these groups—for instance, oZ1—, preferably all three groups, exist, and independently of each other respective pairs each represent two—in turn each bearing hydrogen or a substituent—adjacent carbon atoms and are each part of a conjugated ring, so that oAr1, oAr2, oAr3 (in a circle) each correspondingly represent—optional, according to the existence of oZ1, oZ2 and oZ3—aromatic six-membered rings that are condensed together with the respective hetero-biphenylic structural element to form a tricyclic heteroaromatic structure, where the carbon atoms of the groups oZ1, oZ2, oZ3 alternatively and independently of each other carry hydrogen (H) or other substituents—such as hydrocarbon radicals, halogen atoms —, so that the aromatic rings oAr1, oAr2, oAr3, if present, are either alternatively and independently of each other unsubstituted, singly substituted or doubly substituted derivatives. Preferably, both carbon atoms of the groups oZ1, oZ2, oZ3—insofar as the respective group exists—each carry a hydrogen atom.

For the aromatic cycles and the other substituents of the cycles, the statements already made for formula (I) apply.

In a preferred embodiment according to the disclosure, the photoredox catalyst (c2) is a transition metal complex with ruthenium as central atom and bipyridine or a singly or multiply substituted bipyridine derivative as ligands. In another preferred embodiment according to the disclosure, the photoredox catalyst (c2) is a transition metal complex with iridium as central atom and phenylpyridine or a singly or multiply substituted phenylpyridine derivative as ligands.

Many of the most commonly used photoredox catalysts are polypyridyl transition metal complexes, of ruthenium, copper and iridium, for example. Preferably, the at least one photoredox catalyst (c2) is selected from the group consisting of Ru(bpm)²⁺ (e.g., tris(2,2′-bipyrimidine)ruthenium(II) dichloride), Ru(bpz)₃²⁺ (e.g., tris(2,2′-bipyrazine)ruthenium bis(hexafluorophosphate)), Ru(bpy)₃²⁺, Ru(phen)₃²⁺ (e.g., dichlorotris(1,10-phenanthroline)ruthenium(II) chloride), Ir[dF(CF₃)ppy]₂(dtbbpy)+(e.g., [4,4′-bis(1,1-dimethylethyl)-2,2′-bipyridine-N1,N1′] bis[3,5-difluoro-2-[5-(trifluoromethyl)-2-pyridin-N-yl]phenyl-C]iridium(III) hexafluorophosphate), Ir(ppy)₂(dtbbpy)+(e.g., [Ir(dtbbpy)(ppy)₂][PF₆]), in each case plus one anion or multiple anions (or counterion(s) of the cation), for example chloride or hexafluorophosphate, Ir(Fppy)₃ or fac-Ir(ppy)₃ (fac-tris(2-phenylpyridine)iridium(III)), Ir(ppy)₃, and the copper complex dichloro(1,10-phenanthroline)copper(II) (CAS: 14783-09-6).

In a particularly preferred embodiment according to the disclosure, the photoredox catalyst (c2) is selected from:

### i. [tris(2,2′-bipyridyl)ruthenium(II)]²⁺, [Ru(bpy)₃]²⁺

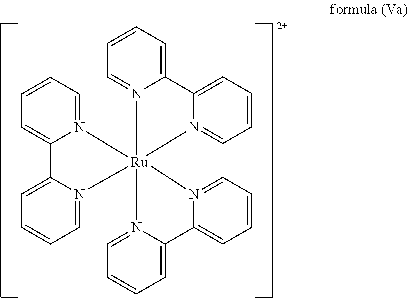

### ii. tris[2-(2,4-difluorophenyl)pyridine]iridium(III), Ir(Fppy)₃; CAS No.: 387859-70-3

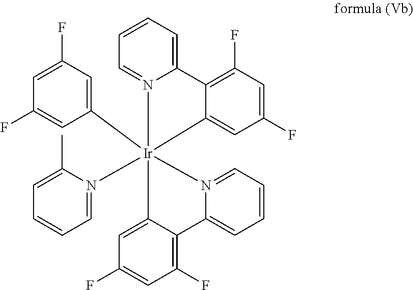

### iii. tris(2-phenylpyridinato)iridium(III), Ir(ppy)₃; CAS No.: 94928-86-6

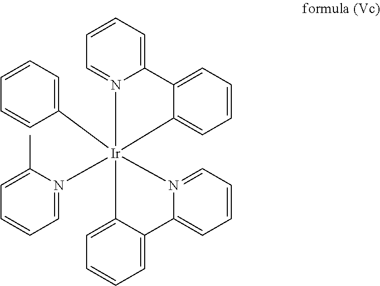

The preferred anion or counterion of the cation of formula (Va) is chloride. The corresponding commercially available product contains water of crystallization.

The particularly preferred embodiment of the photoredox catalyst of formula (Va) is thus tris(2,2′-bipyridyl)ruthenium(II) chloride hexahydrate (CAS No.: 50525-27-4), available from CHEMOS GmbH & Co. KG (Altdorf, Germany, http://www.chemos.de), as well as the photoredox catalysts of the formula (Vc). The photoredox catalyst with the formula (Vb) is available from Strem (Europe) (Bischheim, France, http://www.strem.com).

The fraction of the photoredox catalyst (c2) in the reactive adhesive of the reactive pressure-sensitive adhesive tape of the disclosure is preferably in the range up to about 1.0% by weight, more preferably up to 0.5% by weight, and particularly preferably in the range from about 0.01% by weight to 0.1% by weight of photoredox catalyst, based in each case on 100% by weight of base mass. In one preferred embodiment, in the reactive pressure-sensitive adhesive tape of the disclosure, the at least one reactive adhesive comprises the at least one radical initiator (c1) in the range from 0.1% by weight to 9% by weight, more preferably from 0.1% by weight to 5% by weight and particularly preferably from 0.5% by weight to 2% by weight, and comprises the at least one photoredox catalyst (c2) in the range up to about 1.0% by weight, more preferably in the range up to 0.5% by weight and particularly preferably in the range from about 0.01% by weight to 0.1% by weight, based in each case on 100% by weight of base mass.

In one preferred embodiment, in the reactive pressure-sensitive adhesive tape of the disclosure, the initiator system has an open time of at least 1 minute, preferably 2 minutes and particularly preferably 5 minutes.

In one preferred embodiment, in the reactive pressure-sensitive adhesive tape of the disclosure, the at least one reactive adhesive contains a base mass containing (a) 10% by weight to 90% by weight of at least one poly(meth)acrylate, and (b) 10% by weight to 80% by weight of at least one radically polymerizable monomer or oligomer, based in each case on the total weight of the base mass, and also comprises (c) 0.1% by weight to 10% by weight, based on 100% by weight of the base mass, of at least one initiator system for curing the at least one radically polymerizable monomer or oligomer.

Preferably, in the tape, the at least one reactive adhesive contains a base mass containing (a) 20% by weight to 60% by weight of at least one poly(meth)acrylate, and (b) 20% by weight to 60% by weight of at least one radically polymerizable monomer or oligomer, based in each case on the total weight of the base mass, and also comprises (c) 0.2% by weight to 5% by weight, based on 100% by weight of the base mass, of at least one initiator system for curing the at least one radically polymerizable monomer or oligomer.

With particular preference, in the tape, the at least one reactive adhesive contains a base mass which contains (a) 40% by weight to 55% by weight of at least one poly(meth)acrylate, and (b) 35% by weight to 45% by weight of at least one radically polymerizable monomer or oligomer, based in each case on the total weight of the base mass, and also comprises (c) 0.1% by weight to 2% by weight, based on 100% by weight of the base mass, of at least one initiator system for curing the at least one radically polymerizable monomer or oligomer.

In one embodiment, the reactive adhesive of the reactive pressure-sensitive adhesive tape of the disclosure comprises, in addition to the at least one poly(meth)acrylate of the monomers (i) and (ii), a further polymer or plurality of further polymers (d). In the context of the present disclosure, a further polymer (d) is understood to mean a polymeric compound having a weight average of the molecular weight average distribution M_{w} of 35,000 g/mol or more, determined according to GPC.

Thermoplastic polymers with a crystalline melting temperature of less than 100° C. and/or a softening temperature of less than 100° C. are preferred for adjusting the pressure-sensitive adhesive state or improving the adhesive properties. In this connection, the term “softening temperature” represents the temperature beyond which the thermoplastic pellets stick to each other. If the polymer is a semicrystalline thermoplastic polymer, it has, in addition to its softening temperature (which is related to the melting of the crystallites), very preferably a glass transition temperature of not more than 25° C., preferably not more than 0° C. The further polymer (d) or the plurality of further polymers (d) may, for example, be selected from the group consisting of polyurethane, polyester or copolyester, polyamide or copolyamide, ethylene-vinyl acetate copolymer (EVA or EVAC) and polyvinylcaprolactam. Preferably, the further polymer is a polyurethane, more particularly a thermoplastic polyurethane.

Commercially available thermoplastic polyurethanes are, for example, Desmocoll® 530/1, Desmocoll® 540/3, and Desmomelt® 530 from Covestro AG (Leverkusen, Germany) or IROSTIC® 5-6558-06 and IROSTIC® S 8612 from Huntsman (Huntsman Holland B.V., Botlek-Rotterdam, the Netherlands) or alternative variants from these product lines. In addition, there are the product lines Elastollan® from BASF (Ludwigshafen, Germany) or Pearlbond from Lubrizol (Lubrizol Advanced Materials Europe BVBA, Brussels, Belgium). Preferably, the thermoplastic polyurethane has a softening temperature of less than 100° C., in particular less than 80° C. Preferred examples of such thermoplastic polyurethanes are Desmomelt® 530 and IROSTIC® S-6558-06. Desmomelt® 530 is a hydroxyl-terminated, largely linear, thermoplastic, highly crystallizing polyurethane elastomer. According to the manufacturer, IROSTIC® S-6558-06 is a linear thermoplastic polyurethane for solvent-based adhesives. According to the manufacturer, the characteristics are: very low crystallization rate, long open time, very low activation temperature.

In this case, in the reactive pressure-sensitive adhesive tape of the disclosure, the base mass of the reactive adhesive comprises 1% by weight to 50% by weight, more preferably 10% by weight to 40% by weight, of a further or plurality of further polymers (d), based in each case on the total weight of the base mass of the reactive adhesive.

According to preferred configurations, the base mass of the reactive adhesive contains 10% by weight to 40% by weight, very particularly preferably 20 to 40% by weight, of further polymers (d). This gives the reactive adhesive and thus the disclosure adhesive tape an optimal chemical resistance and at the same time a very good property profile with regard to further requirements, such as in particular the shock resistance.

According to preferred configurations, polyurethanes or ethylene-vinyl acetate are preferred as a further polymer or further polymers, with the total amount of these further polymers here being particularly preferably 10% by weight to 40% by weight, very particularly preferably 20 to 40% by weight. This gives the reactive adhesive and thus the disclosure adhesive tape an optimal chemical resistance and a high shock resistance.

According to further preferred embodiments, the base mass of the reactive adhesive contains 10% by weight to 40% by weight, very particularly preferably 10 to 20% by weight, of further polymers (d). This gives the reactive adhesive and thus the disclosure adhesive tape an optimal chemical resistance and optimized bond strengths to multifarious substrates. According to preferred configurations, polyvinylcaprolactam is preferred in particular as a further polymer.

The stated weight percentages refer to the further polymer or to the sum of all further polymers if two or more polymers are present. Preferably, in the reactive adhesive of the reactive pressure-sensitive adhesive tape of the disclosure, the weight ratio of the entirety of the poly(meth)acrylates to the entirety of the further polymers is 1:0.1 to 1:3. With an even higher fraction of a further polymer or of multiple further polymers, the chemical resistance decreases sharply.

The reactive adhesive of the reactive pressure-sensitive adhesive tape of the disclosure may optionally contain further additives and/or auxiliaries which are known in the prior art. The fraction of the further additives and/or auxiliaries can be in the range from 0% by weight to about 20% by weight, preferably 0% by weight to about 15% by weight, more preferably 0% by weight to about 10% by weight, and most preferably 0% by weight to about 5% by weight, based in each case on 100% by weight of the base mass.

Further additives and/or auxiliaries include, for example, fillers, dyes, nucleating agents, rheological additives (e.g., pyrogenic silica), expandants, adhesion-enhancing additives (adhesion promoters, especially silanes and tackifier resins), compounding agents, plasticizers and/or aging inhibitors and light and UV stabilizers, for example in the form of primary and secondary antioxidants.

In particular, and according to preferred embodiments, the fraction of fillers, such as glass beads or SiLibeads® 5211, is up to 50% by weight, in particular up to 40% by weight, based on 100% by weight of the base mass.

According to preferred embodiments, the reactive adhesive contains at least one rheology-modifying filler, such as in particular silica, preferably in an amount of 1 to 10% by weight, particularly preferably 2 to 5% by weight, based on 100 percent by weight of the base mass.

Particularly preferred additives are silane adhesion promoters. Silane adhesion promoters include, for example, 3-trimethoxysilylpropyl methacrylate (CAS No.: 2530-85-0), available under the trade name Dynasylan® MEMO (Evonik AG, Essen, Germany).

The reactive pressure-sensitive adhesive tape of the disclosure comprises at least one reactive adhesive. In one preferred embodiment, the at least one reactive adhesive is present as an adhesive layer. In this case, the reactive pressure-sensitive adhesive tape of the disclosure relates to an adhesive tape or adhesive film without a carrier layer, i.e., as a carrier-free (foamed and unfoamed) reactive pressure-sensitive adhesive transfer tape. In one preferred embodiment, in the reactive pressure-sensitive adhesive tape, the pressure-sensitive adhesive tape comprises a carrier layer in addition to the adhesive layer. This includes single-sided adhesive tapes as well as double-sided adhesive tapes comprising at least one outer layer consisting of the reactive adhesive of the disclosure, as defined in the claims.

The term adhesive tape is clear to the skilled person in the field of adhesive technology. In the context of the present disclosure, the expression “tape” refers to all thin, flat structures, i.e., structures with a predominant extent in two dimensions, more particularly films, film portions and labels, preferably tapes with extended length and limited width, and corresponding tape portions.

The carrier layer usually refers to the layer of such a multilayer adhesive tape that significantly determines the mechanical and physical properties of the adhesive tape, such as the tear resistance, stretchability, insulation capacity or restoring capacity. Common carrier materials are familiar to the skilled person and are, for example, fabrics, laid scrims and polymeric films, for example PET films and polyolefin films. However, the carrier layer can also be pressure-sensitively adhesive itself.

In the reactive pressure-sensitive adhesive tapes of the disclosure, the adhesive layers can be covered with a so-called release liner for transport, storage or diecutting. This release liner, for example, enables trouble-free unwinding and protects the pressure-sensitive adhesive from contamination. Such release liners usually consist of a one- or two-sidedly siliconized polymeric film (e.g., PET or polypropylene (PP)) or a siliconized paper carrier. It is possible, for example, that the pressure-sensitive adhesive tape may contain further films, foils, layers, carriers, adhesive films, pressure-sensitive adhesive films, release papers and/or release liners.

The layer thickness of the adhesive layer of the reactive adhesive in the disclosure reactive pressure-sensitive adhesive tape is preferably 5 μm to 400 μm (measured with a commercially available thickness gauge, e.g., DM 2000 from Wolf Messtechnik GmbH). A layer thickness of 10 μm to 300 μm is more preferred, a layer thickness of 30 μm to 200 μm is even more preferred, and a layer thickness of 50 μm to 110 μm is the most preferred. Higher layer thicknesses, e.g., of up to 1000 μm, are conceivable and can be realized with the reactive adhesive of the present disclosure. This is especially the case when components with relatively large gaps are installed. Preferred layer thicknesses here are up to 1000 μm, more preferably up to 900 μm and even more preferably up to 800 μm. Often, such adhesive tapes are provided with a carrier layer in the interior to ensure internal strength before curing, so that, exceptionally, a two-sided activation may be necessary.

Also disclosed, on the basis of the disclosure reactive pressure-sensitive adhesive tape, is a method for producing the reactive pressure-sensitive adhesive tape of the disclosure and the use of the reactive pressure-sensitive adhesive tape of the disclosure for bonding two or more components or substrates, preferably at room temperature, by curing the reactive adhesive.

The production of the reactive pressure-sensitive adhesive tape of the disclosure takes place at the latest from the addition of the initiator system, in particular the photoredox catalyst, with exclusion of UV light or visible light of the wavelength by which the respective initiator system, or the respective photoredox catalyst, is excited, more particularly violet and blue light. Generally, these are wavelengths of less than 500 nm. The exclusion can usually be achieved with commercially available yellow light lamps as well as by covering normal light sources that have UV components and/or violet and blue light components in their wavelength spectrum with commercially available UV-protective yellow light films.

The reactive pressure-sensitive adhesive tape of the disclosure is produced by the methods described below:

In a first step, the ingredients (constituents) are dissolved or finely distributed in one or more solvents and/or water. Suitable solvents are known in the prior art, where preferably solvents are used in which at least one of the ingredients has a good solubility. Acetone and methyl ethyl ketone (MEK) are particularly preferred.

As used herein, the term “ingredient” embraces (a) at least one poly(meth)acrylate, (b) at least one radically polymerizable monomer or oligomer, and (c) at least one initiator system for curing the at least one radically polymerizable monomer or oligomer, and optionally (d) at least one further polymer, as defined above.

The dissolved or finely distributed ingredients are then mixed in a second step with conventional stirrers. If appropriate, the ingredients are dissolved, finely distributed and mixed simultaneously.

In a third step, a film, a foil, a layer, a carrier, an adhesive film, a pressure-sensitive adhesive film, preferably a release liner or a release paper is then coated with the mixture of the dissolved, finely distributed ingredients. The coating is carried out according to the usual techniques known in the prior art.

After coating, the solvent is removed in a fourth step by evaporation. Depending on the solvents used, this takes place preferably in the temperature range from 60° C. to 80° C.

Optionally, the reactive adhesive film or the reactive pressure-sensitive adhesive tape of the disclosure can be wound into a roll in a further step.

For storage, the reactive pressure-sensitive adhesive tape of the disclosure is covered with a release liner or paper.

An inventive method for bonding two substrates, preferably at room temperature, using the reactive pressure-sensitive adhesive tape of the present disclosure comprises the following steps:
A) applying the reactive pressure-sensitive adhesive tape to a first substrate
B) activating the reactive pressure-sensitive adhesive tape by irradiation with UV light or blue light, where blue light in particular and for example has a wavelength of 460 nm, preferably by irradiation from a UV-LED lamp
C) joining a second substrate to the reactive pressure-sensitive adhesive tape.

Activation according to step B) can be carried out before or after step A).

Preferably, the activation according to step B) takes place before step C), especially if activation through the first and second substrates is not possible.

Preferably, in this method, in particular on implementation on an industrial scale, irradiation takes place with a wavelength of 365 nm or 385 nm, more preferably with 365 nm.

Likewise preferably, the irradiation can also be carried out with a 460 nm LED radiation source. The results obtained by irradiation with 460 nm light are representative of irradiation with light with a wavelength of 365 nm or 385 nm.

Corresponding UV-LED lamps are available from specialist retailers, for example the LED Cube from the company Hönle (Dr. Hönle AG, Gilching, Germany). Furthermore, in the method of the disclosure, the activation may be less than 45 seconds, preferably less than 30 seconds, more preferably less than 15 seconds, even more preferably less than 10 seconds, in particular less than 7 seconds. In particular, an activation/irradiation time of less than 15 seconds or 10 seconds has proved to be excellently suitable in this method and these are particularly advantageous because they allow very short cycle times in the industrial process.

Another subject of the disclosure is the use of the reactive pressure-sensitive adhesive tape of the disclosure as a bonding means in the production of electronic, optical or precision mechanical devices, more particularly portable electronic, optical or precision mechanical devices.

Preference is given to the use of the reactive pressure-sensitive adhesive tape of the disclosure for producing bonds on materials selected from plastic, metal, glass or ceramic and to the use of the reactive pressure-sensitive adhesive tape of the disclosure as a bonding means in the production of electronic, optical or precision mechanical devices.

Such portable devices are in particular:
Cameras, digital cameras, photography accessories (such as light meters, flashguns, diaphragms, camera casings, lenses, etc.), film cameras, video cameras, small computers (mobile computers, pocket computers, calculators), laptops, notebook personal computers (PCs), netbook PCs, ultrabook PCs, tablet computers, handhelds, electronic diaries and organizers (so-called “electronic organizers” or “personal digital assistants” (PDAs), palmtops), modems;
Computer accessories and controllers for electronic devices, such as mice, drawing pads, graphics tablets, microphones, speakers, games consoles, gamepads, remote controls, remote controllers, touchpads;
Monitors, displays, screens, touch-sensitive screens (sensor screens, “touch-screen devices”), projectors;
Readers for electronic books (“e-books”);
Small televisions (TVs), pocket TVs, film players, video players, radios (including small and pocket radios), Walkmans, Discmans, music players for compact disc (CD), digital video disc (DVD), Blu-ray, cassettes, universal serial bus (USB), MP3, headphones, cordless phones, mobile phones, smartphones, two-way radios, hands-free devices, summoning devices (pagers, beepers);
Mobile defibrillators, blood glucose meters, blood pressure monitors, pedometers, heart rate monitors;
Flashlights, laser pointers;
Mobile detectors, optical magnifiers, far-vision devices, night vision devices, GPS devices, navigation devices, portable satellite communication interface devices;
Data storage devices (USB sticks, external hard drives, memory cards); and wristwatches, digital watches, pocket watches, chain watches, stopwatches.

### Experimental Section

### Raw Materials Used:

| | |
|---|---|
| 2-Phenoxyethyl acrylate (PEA) | CAS No. 48145-04-6, monomer of poly(meth)acrylate, |
| | BASF |
| Methyl methacrylate (MMA) | CAS No. 80-62-6, monomer of poly(meth)acrylate, Sigma- |
| | Aldrich |
| methyl acrylate (MA) | CAS No.: 96-33-3, monomer of poly(meth)acrylate, Sigma- |
| | Aldrich |
| n-Butyl acrylate (BA) | CAS No. 141-32-2, monomer of poly(meth)acrylate, BASF |
| Ethyl acrylate (EA) | CAS No.: 140-88-5, monomer of poly(meth)acrylate, |
| | Sigma-Aldrich |
| Acrylic acid (AA) | CAS No.: 79-10-7, monomer of poly(meth)acrylate, BASF |
| Vazo ® 67 | CAS No. 13472-08-7, 2,2′-azobis(2-methylbutyronitrile), |
| | polymerization initiator, Akzo Nobel |
| N-Vinylcaprolactam (NVC) | CAS No.: 2235-00-9, monomer of poly(N- |
| | vinylcaprolactam), Sigma-Aldrich |
| Di(4-tert-5-butylcyclohexyl) | CAS No. 15520-11-3, polymerization initiator, Akzo Nobel |
| peroxydicarbonate | |
| Irostic ® S-6558-06 | Polymer, linear polyurethane with very low crystallization |
| | rate, Huntsman Holland B. V. |
| 2-Hydroxy-3-phenoxypropyl | CAS No.: 16969-10-1, radically polymerizable monomer, |
| acrylate (HPPA) | Sigma-Aldrich |
| Peroxan ® IHP-50 | 50 percent by weight solution of diisopropyl hydroperoxide |
| | (CAS No.: 26762-93-6) in diisopropylbenzene, radical |
| | initiator, Pergan GmbH |
| Ru(bpy)₃Cl₂/tris(2,2′- | as hexahydrate; tris(2,2′-bipyridyl)ruthenium(II) chloride |
| bipyridyl)ruthenium(II) chloride | hexahydrate, [Ru(bpy)₃Cl₂]•6H₂O; CAS No.: 50525-27-4, |
| | photoredox catalyst, Chemos GmbH |
| Aerosil ® R202 | CAS No.: 7631-86-9, hydrophobized pyrogenic silica, |
| | Evonik AG |

### B. Preparation of the Poly(Meth)Acrylates:

TABLE 1
Composition of the poly(meth)acrylates and comparative polymers

| | | Total fraction of | Molecular weight |
|---|---|---|---|
| Name | Monomer composition | monomers (i) | M_{w} [g/mol] |
| P1 | 69% by weight PEA | 69% | |
| | 31% by weight MMA | | |
| P2 | 90% by weight PEA | 90% | |
| | 10% by weight NVC | | |
| P3 | 29% by weight PEA | 29% | |
| | 51% by weight BA | | |
| | 20% by weight MA | | |
| CP1 | 67% by weight BA | 0% | |
| | 30% by weight EA | | |
| | 3% by weight AA | | |

The polymers P1 to P3 and CP1 were prepared as follows:

A conventional 4 L reactor for radical polymerizations was filled with 320 g of the mixture of monomers specified in Table 1 and 273 g of ethyl acetate/isopropanol (96/04). After 45 minutes of nitrogen gas passing through the reactor with stirring, the reactor was heated to 58° C. and 0.2 g of Vazo® 67 (2,2′-azobis(2-methylbutyronitrile)) was added. A further 480 g of the monomer mixture indicated in Table 1 and 377 g of ethyl acetate were added continuously for 2 hours. Subsequently, the external heating bath was heated to 65° C. and the reaction was conducted constantly at this external temperature. 0.3 g and 0.3 g of 2,2′-azobis(2-methylbutyronitrile) were added after 1 h and after 1.5 h reaction time. To reduce the residual monomers, 0.12 g of di(4-tert-5-butylcyclohexyl) peroxydicarbonate was added after 6 h and again after 7.5 h. The system was diluted once after 2 h and 4 h with 160 g of ethyl acetate. The reaction was terminated after 24 h reaction time and cooling took place to room temperature.

### C. Preparation of Poly(N-Vinylcaprolactam) Solution:

A conventional 10 L glass reactor for radical polymerizations was filled with 4.0 kg of N-vinylcaprolactam, 3.84 kg of acetone and 0.16 kg of isopropanol. The reactor was heated to 65° C. jacket temperature with stirring (70 rpm) while nitrogen gas was passed through it. When the internal temperature reached 58° C., 2.0 g of Vazo® 67 were added. After one hour of further stirring at 65° C. jacket temperature, a further 2.0 g of Vazo® 67 were added. After 6 hours of further stirring at 65° C. jacket temperature, the speed of the stirrer was reduced to 35 rpm. The reaction time was 20 hours. After this time, the solution was cooled to room temperature and diluted with acetone to a solids content of 40.0 percent by weight. The molar mass of the poly(N-vinylcaprolactam) obtained was determined by thermal field flow fractionation, since determination by GPC was not possible. Calibration is carried out in a manner known to the skilled person. Result: Mₙ=74,000 g/mol, M_{w}=116,500 g/mol. Table 2 refers to the polymer as a solid.

### D. Production of Reactive Adhesive:

The reactive adhesives were produced in the laboratory in accordance with the quantities specified in Table 2 below. The epoxy compounds were added to the polymer present in solvent and the photoinitiator was subsequently added by stirring. If commercial polymers were used, they were prepared as a 40% solution in butanone.

TABLE 2
Compositions of the reactive adhesives K1 to K4 according
to the disclosure and of the comparative reactive adhesives
C1 and C2 (all information in parts by weight):

| Components | K1 | K2 | K3 | K4 | C1 | C2 |
|---|---|---|---|---|---|---|
| Base composition | | | | | | |
| P1 | 58.7 | | 16 | | | |
| P2 | | 58.7 | | | | |
| P3 | | | | 42.7 | | |
| Irostic ® S-6558-06 (PU) | | | 42.7 | | 42.7 | |
| Poly(N-vinylcaprolactam) | | | | 16 | 16 | 15 |
| CP1 | | | | | | 55 |
| HPPA | 41.3 | 41.3 | 41.3 | 41.3 | 41.3 | 30 |
| Initiator system | | | | | | |
| Peroxan ® IHP-50 | 2.5 | 2.5 | 2.5 | 2.5 | 2.5 | 2.5 |
| [Ru(bpy)₃]Cl₂ | 0.03 | 0.03 | 0.03 | 0.03 | 0.03 | 0.03 |
| Filler | | | | | | |
| Aerosil ® R202 | 4 | 4 | 4 | 4 | 4 | 4 |

### E. Production of Reactive Pressure-Sensitive Adhesive Tapes:

For the production of the reactive adhesive layers, i.e., the carrier-free pressure-sensitive adhesive tapes, the various reactive adhesives were applied from a solution to a conventional liner (siliconized polyester film) by means of a laboratory coating device and dried. The size of the adhesive layer was about 21 cm×30 cm and the adhesive layer thickness after drying is 100±5 jam. The drying was carried out first at room temperature (RT) for 15 minutes and for 15 minutes at 120° C. in a laboratory drying oven. The dried adhesive layers were each laminated on the open side immediately after drying with a second liner (siliconized polyester film with lower release force).

### F. Test Methods and Test Results

### Push-Out (PC—PC)—Initial:

The push-out test enables conclusions as to the bond strength of an adhesive product in the direction of the adhesive layer normal. Provided are a circular first substrate (1) (polycarbonate, Makrolon® 099, thickness 3 mm) with a diameter of 21 mm, a square second substrate (2) (polycarbonate, Makrolon® 099, thickness 3 mm) with a side length of 40 mm—with a circular, centrally arranged opening (hole) of 9 mm diameter, and the adhesive film sample to be examined, punched in a ring shape with an outer diameter of 18 mm and an inner diameter of 13 mm, so that a ring with a land width of 5 mm was created.

A test specimen is produced from the three components mentioned above, by bonding the adhesive product by the free surface to the middle of the substrate (1). Then the temporary protective film (siliconized PET liner) is removed and irradiation takes place with at least 50 J/cm² with a blue light LED (LED Spot 100 HP IC 460 nm from Hönle AG). The activation can also be done instead with a 365 nm UV-LED (Hönle AG).

This assembly is applied concentrically to the substrate (2) within 2 minutes by the now exposed side of the adhesive product, i.e., in such a way that the circular recess of the substrate (2) is arranged exactly in the middle above the circular first substrate 1 (the bond area is thus 151 mm²) and pressed at a pressure of at least 3 bar for at least 30 seconds, forming the test specimen.

After pressing, the test specimens are conditioned for 72 hours at 23° C./50% relative humidity (r.h.). After storage, the adhesive assembly is clamped into a sample holder so that the assembly is aligned horizontally. The test specimen is inserted in the sample holder with the polycarbonate disk (substrate (1)) facing downward and the bond strength is measured in a Zwick [Z020]. For this purpose, a steel punch with a diameter of 7 mm is driven through the circular opening in substrate (2) and a determination is made of the force required to separate the circular substrate (1) from the square substrate (2). The output value is the specified force divided by the bond area and the force is reported in MPa.

Three samples per product are tested and the mean value is reported as an index of the bond strength.

Push-Out (PC—PC)—after 72 h at 65° C. in Isopropanol/Water:

To determine the chemical resistance of the bonding, push-out test specimens, which are assembled as described above, were placed for 72 h in a 65° C. bath of isopropanol/water (70/30, i.e., 70% volume fractions to 30% volume fractions). After removal, the test specimens were reconditioned at 23° C. and 50% r.h. for one hour. The bond strength was then measured as described in Push-out—initial.

To determine the bond strength on SUS, a 3 mm thick circular steel disk (diameter 21 mm) was chosen as substrate (1) and a 2 mm thick square steel substrate with 40 mm side length and a circular, centrally arranged opening (hole) of 9 mm diameter was chosen as substrate (2). The steel substrates are made of VA-1.4301 steel (mirror polished on one side).

### Peel Adhesion (on Steel):

Peel adhesion is determined here on steel analogously to International Organization for Standardization (ISO) 29862:2007 (method 3) at 23° C. and 50% relative atmospheric humidity at a peel rate of 300 mm/min and a peel angle of 180°. An etched PET film with a thickness of 36 m, as available from Coveme (Italy), is used as a reinforcing film. The bonding of a 2 cm-wide test strip is undertaken here by means of a 4 kg roll applicator at a temperature of 23° C. The adhesive tape is peeled off immediately after application. The measured value (in N/cm) is obtained as the average value from three individual measurements.

Molecular weight Mₙ, M_{w}

The values reported for number-average molecular weight Mₙ and weight-average molecular weight M_{w} in this document relate to determination by gel permeation chromatography (GPC). The determination is carried out using a clear-filtered 100 μL sample (sample concentration 4 g/L). Tetrahydrofuran with 0.1% by volume trifluoroacetic acid is used as eluent. The measurement is carried out at 25° C. The guard column is a Polymer Standard Service (PSS)-SDV column, 5 μm, 10³ Å, 8.0 mm*50 mm (data here and below in the following order: type, particle size, porosity, internal diameter*length; 1 Å=10⁻¹⁰ μm). For separation, a combination of the columns of the type PSS-SDV, 5 μm, 10³ Å, 10⁵ Å and 10⁶ Å each of 8.0 mm*300 mm is used (columns from the company Polymer Standards Service; detection by differential refractometer Shodex R171). The flow rate is 1.0 mL per minute. Calibration is performed against PMMA standards (polymethyl methacrylate calibration) for polyacrylates and polar molecules, such as polyurethane, for example. The calibration is performed using the commercially available ReadyCal kit Poly(styrene) high from PSS Polymer Standard Service GmbH, Mainz. This is converted universally into polymethyl methacrylate (PMMA) using the Mark-Houwink parameters K and α, so that the data are expressed in PMMA mass equivalents. For other molecules, calibration takes place against PS standards (polystyrene calibration)

TABLE 3
Push-out and peel adhesion results

| Test | K1 | K2 | K3 | K4 | C1 | C2 |
|---|---|---|---|---|---|---|
| Push-out (PC-PC) - initial [MPa] | 4.4 | 3.0 | 3.1 | 2.1 | 6.3 | 1.0 |
| Push-out (SUS-SUS) - initial [MPa] | 12.7 | 8.1 | 2.8 | 6.9 | 8.9 | 2.2 |
| Push-out (PC-PC) - after 72 h at | 0.3 | 0.5 | 0.1 | 0.05 | n.b.2 | n.b.2 |
| 65° C. in isopropanol/water [MPa] | | | | | | |
| Push-out (PC-PC) - after 72 h at | Yes | Yes | Yes | Yes | No | No |
| 65° C. in isopropanol/water | | | | | | |
| Passed: Yes or no | | | | | | |
| Peel adhesion, steel | AF, >1 N/cm | AF, >1 N/cm | AF, >1 N/cm | AF, >1 N/cm | AF, >1 N/cm | AF, >1 N/cm |

AF = adhesive failure;
n.b.2 = The bond parted either in isopropanol/water after 48 hours of storage or during the preparation of the samples for the push-out tests. Therefore, the push-out test after 72 hours of storage in isopropanol/water cannot be performed.

All adhesives K1 to K4 according to the disclosure show excellent initial bond strengths (push-out PC—PC and SUS—SUS). Even after immersion in a mixture of isopropanol and water for 72 hours, the bond strengths (in the case of PC—PC) are still sufficiently high or excellent, so that the adhesives K1 to K4 according to the disclosure have a good to very good chemical resistance.

A value of 0.1 MPa for K3 is also a sufficient bond strength in the present case and proves the chemical resistance of example K3. The skilled person is aware that in the prior art there are no known reactive pressure-sensitive adhesives which withstand such harsh storage conditions at 65° C. for 72 h in isopropanol and water.

After 72 hours of storage in isopropanol/water, the push-out test is passed if the bond withstands these storage conditions and measurable values of >0.01 MPa are obtained.

Although the comparative adhesive C1 showed an acceptable initial bond strength in the push-out test, it did not show any chemical resistance, since the bond already parted during the immersion time in the mixture of isopropanol and water or at the latest during the sample preparation of the push-out tests after removal from the mixture. The comparative adhesive C2 showed poor initial bond strengths on PC—PC. In the case of C2, the bond also parted during the immersion time in the mixture of isopropanol and water or during the sample preparation of the push-out tests after removal from the mixture, so that C2 as well did not exhibit sufficient chemical resistance. K4 surprisingly shows that even polymers with low phenyl group contents in combination with the radically polymerizable monomer lead to an adhesive which passes the harsh chemical resistance test, compared to C2 without phenyl groups or C1. With an increasing phenyl group content, the measured values after harsh storage can also be further improved (K1, K2).

According to a first aspect of the present disclosure, a reactive pressure-sensitive adhesive tape comprising at least one reactive adhesive containing a base mass, the base mass comprising (a) at least one poly(meth)acrylate, and (b) at least one radically polymerizable monomer or oligomer, and the at least one reactive adhesive additionally comprising (c) at least one initiator system for curing the at least one radically polymerizable monomer or oligomer, wherein the at least one poly(meth)acrylate derives from a monomer composition which comprises (i) 15% by weight to 100% by weight of one or more monomers selected from the group consisting of (a) one or more monomers of formula (I)

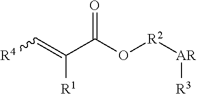

in which R is a hydrogen atom or a methyl group, R² is an unsubstituted, linear or branched C₁-C₂₂ alkyl chain, AR is an aromatic radical, R³ is H, an unsubstituted, linear or branched C₁-C₅ alkyl chain, a hydroxyl group, a C₁-C₁₀ alkoxy group or an aryloxy group, R⁴ is H or a phenyl ring, (b) one or more monomers of formula (II)

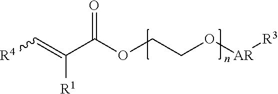

in which R¹ is a hydrogen atom or a methyl group, AR is an aromatic radical, R³ is H, an unsubstituted, linear or branched C₁-C₅ alkyl chain, a hydroxyl group, a C₁-C₁₀ alkoxy group or an aryloxy group, and R⁴ is H or a phenyl ring, and n is 0 to 10, (c) styrene, and (d) methylstyrene; and the one or more comonomers being selected from a group consisting of (meth)acrylate monomers and copolymerizable vinyl monomers, and the one or more comonomers not corresponding to the one or more monomers of formula (I), the one or more monomers of formula (II), styrene, and methylstyrene, weight fractions being based in each case on a total weight of the monomer composition.

According to a second aspect of the present disclosure, the reactive pressure-sensitive adhesive tape of the first aspect is presented, wherein the monomer composition from which the at least one poly(meth)acrylate derives comprises (i) 15% by weight to 100% by weight of one or more monomers selected from the group consisting of (a) one or more monomers of formula (Ia)

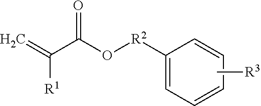

in which R¹ is a hydrogen atom or a methyl group, R² is an unsubstituted, linear or branched C₁-C₂₂ alkyl chain, and R³ is H, an unsubstituted, linear or branched C₁-C₅ alkyl chain, a hydroxyl group, a C₁-C₁₀ alkoxy group or an aryloxy group, and (b) one or more monomers of formula (IIa)

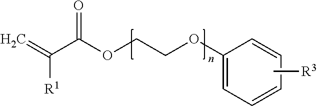

in which R¹ is a hydrogen atom or a methyl group, R³ is H, an unsubstituted, linear or branched C₁-C₅ alkyl chain, a hydroxyl group, a C₁-C₁₀ alkoxy group or an aryloxy group, and n is 0 to 10; and (ii) 0% by weight to 85% by weight of one or more comonomers, the one or more comonomers being selected from a group consisting of (meth)acrylate monomers, and the one or more comonomers not corresponding to the one or more monomers of formula (Ia), the one or more monomers of formula (IIa), styrene, and methylstyrene, and a glass transition temperature (T_{g}) of a homopolymer of the one or more comonomers being greater than 0° C., the weight fractions being based in each case on the total weight of the monomer composition.

According to a third aspect of the present disclosure, the reactive pressure-sensitive adhesive tape of any one of the first through second aspects is presented, wherein the one or more monomers (i) are selected from the group consisting of benzyl acrylate, phenyl acrylate, benzyl methacrylate, phenyl methacrylate, 2-phenoxyethyl acrylate, and 2-phenoxyethyl methacrylate.

According to a fourth aspect of the present disclosure, the reactive pressure-sensitive adhesive tape of any one of the first through third aspects is presented, wherein the monomer composition from which the at least one poly(meth)acrylate derives consists of 55% by weight to 100% by weight of the one or more monomers (i) and 0% by weight to 45% by weight of the one or more comonomers (ii), more preferably of 65% by weight to 100% by weight of monomers (i) and 0% by weight to 35% by weight of comonomers (ii) and particularly preferably of 80% by weight to 100% by weight of monomers (i) and 0% by weight to 20% by weight of comonomers (ii), the weight fractions being based in each case on the total weight of the monomer composition.

According to a fifth aspect of the present disclosure, the reactive pressure-sensitive adhesive tape of any one of the first through fourth aspects is presented, wherein the one or more comonomers (ii) of the monomer composition from which the at least one poly(meth)acrylate derives comprises a nitrogen-containing comonomer (ii).

According to a sixth aspect of the present disclosure, the reactive pressure-sensitive adhesive tape of any one of the first through fifth aspects is presented, wherein the base mass of the at least one reactive adhesive comprises at least one radically polymerizable oligomer.

According to a seventh aspect of the present disclosure, the reactive pressure-sensitive adhesive tape of any one of the first through fifth aspects is presented, wherein the at least one radically polymerizable monomer or oligomer has a boiling point at 1 mbar of at least 30° C., preferably at least 60° C., and particularly preferably of at least 80° C., or is present as a solid at 23° C.

According to an eighth aspect of the present disclosure, the reactive pressure-sensitive adhesive tape of any one of the first through seventh aspects is presented, wherein the at least one radically polymerizable monomer or oligomer (b) is selected from the group consisting of acrylic acid esters, methacrylic acid esters, vinyl compounds, compounds with carbon-carbon double bonds, and crosslinking radically polymerizable monomers, such as diacrylates, dimethacrylates, triacrylates, trimethacrylates and higher-functional acrylates or higher-functional methacrylates, preferably 2-phenoxyethyl acrylate, 2-phenoxyethyl methacrylate, 2-hydroxy-3-phenoxypropyl acrylate, 2-hydroxy-3-phenoxypropyl methacrylate, 2-[2-(methacryloyloxy)ethoxycarbonyl]benzoic acid, 2-[[(phenylamino)carbonyl]oxy]ethyl methacrylate, 2-tert-butyl-6-[(3-tert-butyl-2-hydroxy-5-methylphenyl)methyl]-4-methylphenyl prop-2-enoate, (5-ethyl-1,3-dioxan-5-yl)methyl acrylate, (2-oxo-1,3-dioxolan-4-yl)methyl methacrylate, di(ethylene glycol) 2-ethylhexyl ether acrylate, (2,2-dimethyl-1,3-dioxolan-4-yl)methyl prop-2-enoate, succinic acid mono[2-(acryloyloxy)ethyl ester], succinic acid mono[2-(methacryloyloxy)ethyl ester], (2,2-pentamethylene-1,3-oxazolid-3-yl)ethyl methacrylate, 2-hydroxy-3-(prop-2-enoyloxy)propyl 2-methyl-2-propylhexanoate, 2-[[(butylamino)carbonyl]oxy]ethyl acrylate, stearyl acrylate, stearyl methacrylate, diurethane dimethacrylate (isomer mixture), bisphenol A glycerolate dimethacrylate, bisphenol A dimethacrylate, ethylene glycol diacrylate, ethylene glycol dimethacrylate, trimethyloylpropane propoxylate triacrylate, trimethyloylpropane triacrylate, and di(trimethylolpropane) tetraacrylate.

According to a ninth aspect of the present disclosure, the reactive pressure-sensitive adhesive tape of any one of the first through eighth aspects is presented, wherein the base mass of the at least one reactive adhesive further comprises (d) one or more further polymers.

According to a tenth aspect of the present disclosure, the reactive pressure-sensitive adhesive tape of the ninth aspect is presented, wherein the one or more further polymers (d) is selected from the group consisting of polyurethane, polyester or copolyester, polyamide or copolyamide, ethylene-vinyl acetate copolymer, and polyvinylcaprolactam.

According to an eleventh aspect of the present disclosure, the reactive pressure-sensitive adhesive tape of the tenth aspect is presented, wherein the one or more further polymers (d) is a polyurethane, more particularly a thermoplastic polyurethane.

According to a twelfth aspect of the present disclosure, the reactive pressure-sensitive adhesive tape of any one of the first through eleventh aspects is presented, wherein (1) the base mass of the at least one reactive adhesive comprises (a) 10% by weight to 90% by weight, more preferably 20% by weight to 60% by weight, and more particularly preferably 40% by weight to 55% by weight of the at least one poly(meth)acrylate, and (b) 10% by weight to 80% by weight, more preferably 20% by weight to 60% by weight, and more particularly preferably 35% by weight to 45% by weight of the at least one radically polymerizable monomer or oligomer, based in each case on a total weight of the base mass, and (2) the at least one reactive adhesive additionally comprises (c) 0.1% by weight to 10% by weight, more preferably 0.1% by weight to 5% by weight, and more particularly preferably 0.1% by weight to 2% by weight, based on 100% by weight of the base mass, of the at least one initiator system for curing the at least one radically polymerizable monomer or oligomer.

According to a thirteenth aspect of the present disclosure, the reactive pressure-sensitive adhesive tape of the twelfth aspect is presented, wherein the base mass of the at least one reactive adhesive further comprises (d) 1% by weight to 50% by weight, more preferably 1% by weight to 40% by weight, of one or more further polymers, based in each case on the total weight of the base mass of the at least one reactive adhesive.

According to a fourteenth aspect of the present disclosure, the reactive pressure-sensitive adhesive tape of any one of the first through thirteenth aspects is presented, wherein the at least one initiator system for curing the at least one radically polymerizable monomer or oligomer consists of at least one radical initiator (c1) and at least one photoredox catalyst (c2).

According to a fifteenth aspect of the present disclosure, the reactive pressure-sensitive adhesive tape of the fourteenth aspect is presented, wherein the at least one radical initiator (c1) is an organic peroxide, preferably a hydroperoxide, and most preferably diisopropylbenzene hydroperoxide.

According to a sixteenth aspect of the present disclosure, the reactive pressure-sensitive adhesive tape of any one of the fourteenth through fifteenth aspects is presented, wherein the at least one photoredox catalyst (c2) is selected from the group consisting of Ru(bpm)²⁺ anion, Ru(bpz)₃²⁺ anion, Ru(bpy)₃²⁺ anion, Ru(phen)₃²⁺ anion, Ir[dF(CF₃)ppy]₂(dtbbpy)⁺ anion, Ir(ppy)₃, Ir(ppy)₂(dtbbpy)⁺ anion, Ir(Fppy)₃ or fac-Ir(ppy)₃, and Cu(dap)²⁺ anion.

According to a seventeenth aspect of the present disclosure, the reactive pressure-sensitive adhesive tape of any one of the fourteenth through sixteenth aspects is presented, wherein the at least one reactive adhesive comprises the at least one radical initiator (c1) in a range from 0.1% by weight to 9% by weight, more preferably from 0.1% by weight to 5% by weight, and particularly preferably from 0.5% by weight to 2% by weight, and comprises the at least one photoredox catalyst (c2) in a range of up to about 1.0% by weight, more preferably in a range of up to 0.5% by weight, and particularly preferably in a range from about 0.01% by weight to 0.1% by weight, based on 100% by weight of the base mass.

According to an eighteenth aspect of the present disclosure, an adhesive composition comprises: (1) a base composition comprising: (a) 10% by weight to 60% by weight of a polymerized monomer composition consisting of one or more monomers selected from a group consisting of 2-phenoxyethyl acrylate, methyl methacrylate, N-vinylcaprolactam, n-butyl acrylate, and methyl acrylate, (b) 35% by weight to 45% by weight of 2-hydroxy-3-phenoxypropyl acrylate, and (c) optionally 1% by weight to 50% by weight of one or more further polymers, wherein a combined weight percentage of the polymerized monomer composition, the 2-hydroxy-3-phenoxypropyl acrylate, and the one or more further polymers is 100% by weight of the base composition; (2) from 0.1% by weight to 5% by weight of one or more radical initiators, based on 100% by weight of the base composition; (3) from about 0.01% by weight to 0.1% by weight of one or more photoredox catalysts, based on 100% by weight of base composition; and (4) from 2 to 5% by weight of at least one rheology-modifying filler, based on 100 percent by weight of the base composition, wherein (a) the adhesive composition comprises (i) an uncured state and, (ii) after curing from the uncured state, a cured state, (b) in the uncured state, the adhesive composition is a pressure-sensitive adhesive, (c) in the cured state, the adhesive composition is a (semi-)structural adhesive, and (d) during curing, 2-hydroxy-3-phenoxypropyl acrylate radically polymerizes.

According to a nineteenth aspect of the present disclosure, the adhesive composition of the eighteenth aspect is presented, wherein the base composition further comprises the one or more further polymers selected from a group consisting of poly(N-vinylcaprolactam) and a thermoplastic polyurethane.

According to a twentieth aspect of the present disclosure, the adhesive composition of any one of the eighteenth through nineteenth aspects is presented, wherein (i) the one or more radical initiators comprises diisopropylbenzene hydroperoxide, (ii) the one or more photoredox catalysts comprises [Ru(bpy)₃Cl₂]·6H₂O, and (iii) the at least one rheology-modifying filler comprises silica.

What is claimed is:

1. A reactive pressure-sensitive adhesive tape comprising at least one reactive adhesive comprising a base mass, the base mass comprising
(a) at least one poly(meth)acrylate, and
(b) at least one radically polymerizable monomer or oligomer,
and the at least one reactive adhesive additionally comprising
(c) at least one initiator system for curing the at least one radically polymerizable monomer or oligomer,
wherein
the at least one poly(meth)acrylate derives from a monomer composition which comprises
(i) 15% by weight to 100% by weight of one or more monomers selected from the group consisting of
a. one or more monomers of formula (I) 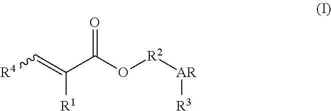
in which R¹ is a hydrogen atom or a methyl group,
R² is an unsubstituted, linear or branched C₁-C₂₂ alkyl chain,
AR is an aromatic radical,
R³ is H, an unsubstituted, linear or branched C₁-C₅ alkyl chain, a hydroxyl group, a C₁-C₁₀ alkoxy group or an aryloxy group,
R⁴ is H or a phenyl ring,
b. one or more monomers of formula (II) 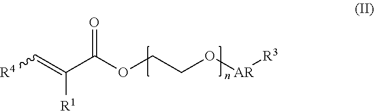
in which R¹ is a hydrogen atom or a methyl group,
AR is an aromatic radical,
R³ is H, an unsubstituted, linear or branched C₁-C₅ alkyl chain, a hydroxyl group, a C₁-C₁₀ alkoxy group or an aryloxy group, and
R⁴ is H or a phenyl ring, and n is 0 to 10,
c. styrene, and
d. methylstyrene; and
(ii) 0% by weight to 85% by weight of one or more comonomers,
the one or more comonomers being selected from a group consisting of (meth)acrylate monomers and copolymerizable vinyl monomers, and
the one or more comonomers not corresponding to the one or more monomers of formula (I), the one or more monomers of formula (II), styrene, and methylstyrene, weight fractions being based in each case on a total weight of the monomer composition.

2. The reactive pressure-sensitive adhesive tape of claim 1, wherein
the monomer composition from which the at least one poly(meth)acrylate derives comprises
(i) 15% by weight to 100% by weight of one or more monomers selected from the group consisting of
a. one or more monomers of formula (Ia) 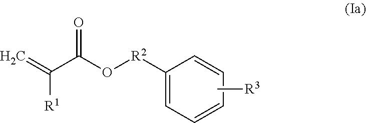
in which R¹ is a hydrogen atom or a methyl group,
R² is an unsubstituted, linear or branched C₁-C₂₂ alkyl chain, and
R³ is H, an unsubstituted, linear or branched C₁-C₅ alkyl chain, a hydroxyl group, a C₁-C₁₀ alkoxy group or an aryloxy group, and
b. one or more monomers of formula (IIa) 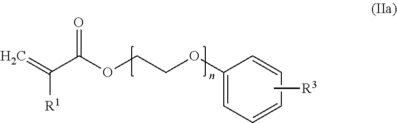
in which R¹ is a hydrogen atom or a methyl group,
R³ is H, an unsubstituted, linear or branched C₁-C₅ alkyl chain, a hydroxyl group, a C₁-C₁₀ alkoxy group or an aryloxy group, and n is 0 to 10; and
(ii) 0% by weight to 85% by weight of one or more comonomers,
the one or more comonomers being selected from the group consisting of (meth)acrylate monomers, and
the one or more comonomers not corresponding to the one or more monomers of formula (Ia), the one or more monomers of formula (IIa), styrene, and methylstyrene, and
a glass transition temperature (T_{g}) of a homopolymer of the one or more comonomers being greater than 0° C.,
the weight fractions being based in each case on the total weight of the monomer composition.

3. The reactive pressure-sensitive adhesive tape of claim 1, wherein the one or more monomers (i) are selected from the group consisting of benzyl acrylate, phenyl acrylate, benzyl methacrylate, phenyl methacrylate, 2-phenoxyethyl acrylate, and 2-phenoxyethyl methacrylate.

4. The reactive pressure-sensitive adhesive tape of claim 1, wherein the monomer composition from which the at least one poly(meth)acrylate derives consists of 80% by weight to 100% by weight of the one or more monomers (i) and 0% by weight to 20% by weight of the one or more comonomers, the weight fractions being based in each case on the total weight of the monomer composition.

5. The reactive pressure-sensitive adhesive tape of claim 1, wherein the one or more comonomers (ii) of the monomer composition from which the at least one poly(meth)acrylate derives comprises a nitrogen-containing comonomer (ii).

6. The reactive pressure-sensitive adhesive tape of claim 1, wherein the base mass of the at least one reactive adhesive comprises at least one radically polymerizable oligomer.

7. The reactive pressure-sensitive adhesive tape of claim 1, wherein the at least one radically polymerizable monomer or oligomer is present as a solid at 23° C.

8. The reactive pressure-sensitive adhesive tape of claim 1, wherein the at least one radically polymerizable monomer or oligomer (b) is selected from the group consisting of 2-phenoxyethyl acrylate, 2-phenoxyethyl methacrylate, 2-hydroxy-3-phenoxypropyl acrylate, 2-hydroxy-3-phenoxypropyl methacrylate, 2-[2-(methacryloyloxy)ethoxycarbonyl]benzoic acid, 2-[[(phenylamino)carbonyl]oxy]ethyl methacrylate, 2-tert-butyl-6-[(3-tert-butyl-2-hydroxy-5-methylphenyl)methyl]-4-methylphenyl prop-2-enoate, (5-ethyl-1,3-dioxan-5-yl)methyl acrylate, (2-oxo-1,3-dioxolan-4-yl)methyl methacrylate, di(ethylene glycol) 2-ethylhexyl ether acrylate, (2,2-dimethyl-1,3-dioxolan-4-yl)methyl prop-2-enoate, succinic acid mono[2-(acryloyloxy)ethyl ester], succinic acid mono[2-(methacryloyloxy)ethyl ester], (2,2-pentamethylene-1,3-oxazolid-3-yl)ethyl methacrylate, 2-hydroxy-3-(prop-2-enoyloxy)propyl 2-methyl-2-propylhexanoate, 2-[[(butylamino)carbonyl]oxy]ethyl acrylate, stearyl acrylate, stearyl methacrylate, diurethane dimethacrylate (isomer mixture), bisphenol A glycerolate dimethacrylate, bisphenol A dimethacrylate, ethylene glycol diacrylate, ethylene glycol dimethacrylate, trimethyloylpropane propoxylate triacrylate, trimethyloylpropane triacrylate, and di(trimethylolpropane) tetraacrylate.

9. The reactive pressure-sensitive adhesive tape of claim 1, wherein the base mass of the at least one reactive adhesive further comprises (d) one or more further polymers.

10. The reactive pressure-sensitive adhesive tape of claim 9, wherein the one or more further polymers (d) is selected from the group consisting of polyurethane, polyester or copolyester, polyamide or copolyamide, ethylene-vinyl acetate copolymer, and polyvinylcaprolactam.

11. The reactive pressure-sensitive adhesive tape of claim 10, wherein the one or more further polymers (d) is a thermoplastic polyurethane.

12. The reactive pressure-sensitive adhesive tape of claim 1, wherein the base mass of the at least one reactive adhesive comprises
(a) 40% by weight to 55% by weight of the at least one poly(meth)acrylate, and
(b) 35% by weight to 45% by weight of the at least one radically polymerizable monomer or oligomer, based in each case on a total weight of the base mass,
and the at least one reactive adhesive additionally comprises
(c) 0.1% by weight to 2% by weight, based on 100% by weight of the base mass, of the at least one initiator system for curing the at least one radically polymerizable monomer or oligomer.

13. The reactive pressure-sensitive adhesive tape of claim 12, wherein the base mass of the at least one reactive adhesive further comprises
(d) 1% by weight to 40% by weight, of one or more further polymers, based in each case on the total weight of the base mass of the at least one reactive adhesive.

14. The reactive pressure-sensitive adhesive tape of claim 1, wherein the at least one initiator system for curing the at least one radically polymerizable monomer or oligomer consists of at least one radical initiator (c1) and at least one photoredox catalyst (c2).

15. The reactive pressure-sensitive adhesive tape of claim 14, wherein the at least one radical initiator (c1) is diisopropylbenzene hydroperoxide.

16. The reactive pressure-sensitive adhesive tape of claim 14, wherein the at least one photoredox catalyst (c2) is selected from the group consisting of Ru(bpm)²⁺ anion, Ru(bpz)₃²⁺ anion, Ru(bpy)₃²⁺ anion, Ru(phen)₃²⁺ anion, Ir[dF(CF₃)ppy]₂(dtbbpy)⁺ anion, Ir(ppy)₃, Ir(ppy)₂(dtbbpy)⁺ anion, Ir(Fppy)₃ or fac-Ir(ppy)₃, and Cu(dap)²⁺ anion.

17. The reactive pressure-sensitive adhesive tape of claim 14, wherein the at least one reactive adhesive comprises the at least one radical initiator (c1) in a range from 0.5% by weight to 2% by weight, and comprises the at least one photoredox catalyst (c2) in a range from about 0.01% by weight to 0.1% by weight, based on 100% by weight of the base mass.

18. An adhesive composition comprising:
a base composition comprising:
10% by weight to 60% by weight of a polymerized monomer composition consisting of one or more of monomers selected from a group consisting of 2-phenoxyethyl acrylate, methyl methacrylate, N-vinylcaprolactam, n-butyl acrylate, and methyl acrylate,
35% by weight to 45% by weight of 2-hydroxy-3-phenoxypropyl acrylate, and optionally 1% by weight to 50% by weight of one or more further polymers,
wherein a combined weight percentage of the polymerized monomer composition, the 2-hydroxy-3-phenoxypropyl acrylate, and the one or more further polymers is 100% by weight of the base composition;
from 0.1% by weight to 5% by weight of one or more radical initiators, based on 100% by weight of the base composition;
from about 0.01% by weight to 0.1% by weight of one or more photoredox catalysts, based on 100% by weight of the base composition; and
from 2 to 5% by weight of at least one rheology-modifying filler, based on 100 percent by weight of the base composition,
wherein, the adhesive composition comprises (i) an uncured state and, (ii) after curing from the uncured state, a cured state,
wherein, in the uncured state, the adhesive composition is a pressure-sensitive adhesive,
wherein, in the cured state, the adhesive composition is a (semi-)structural adhesive, and
wherein, during curing, 2-hydroxy-3-phenoxypropyl acrylate radically polymerizes.

19. The adhesive composition of claim 18, wherein the base composition further comprises the one or more further polymers selected from a group consisting of poly(N-vinylcaprolactam) and a thermoplastic polyurethane.

20. The adhesive composition of claim 18, wherein
the one or more radical initiators comprises diisopropylbenzene hydroperoxide,
the one or more photoredox catalysts comprises [Ru(bpy)₃Cl₂]·6H₂O, and
the at least one rheology-modifying filler comprises silica.
